(19) United States
(12) Patent Application Publication
(10) Pub. No.: US 2019/0121148 A1
(43) Pub. Date: Apr. 25, 2019

(54) GRATING, STEREOSCOPIC THREE-DIMENSIONAL (3D) DISPLAY DEVICE, AND DISPLAY METHOD

(71) Applicant: SUPERD TECHNOLOGY CO., LTD., Shenzhen (CN)

(72) Inventors: Honglei WANG, Shenzhen (CN); Peiyun JIAN, Shenzhen (CN); Xiaoda GONG, Shenzhen (CN); Lei SONG, Shenzhen (CN)

(21) Appl. No.: 16/100,711

(22) Filed: Aug. 10, 2018

(30) Foreign Application Priority Data
Oct. 24, 2017 (CN) 201711003500.0
Oct. 24, 2017 (CN) 201711003630.4
Oct. 24, 2017 (CN) 201711007788.9

(51) Int. Cl. G02B 27/22; H04N 13/359; H04N 13/122; G02B 27/12; G02B 5/30; H04N 13/366

(52) U.S. Cl. CPC G02B 27/22; H04N 13/359; H04N 13/366; G02B 27/123; G02B 5/3075; H04N 13/122

(57) ABSTRACT

A stereoscopic 3D display device, a display method and a grating are provided. The stereoscopic 3D display device is compatible of a 2D display mode, a landscape screen 3D display mode and a portrait screen 3D display mode. The stereoscopic 3D display device comprises a display screen; and a grating arranged opposite to the display screen, wherein in each of the 2D display mode, the landscape screen 3D display mode and the portrait screen 3D display mode, the grating is in a light-splitting state. The grating includes a plurality of grating units arranged in parallel. A grating unit of the plurality of grating units is obliquely disposed with respect to a long side or a short side of the display screen, and an angle formed between the grating unit and the long side or the short side of the display screen is between 30° and 40°.

### CROSS-REFERENCES TO RELATED APPLICATIONS

This application claims priority of Chinese Application No. 201711007788.9, filed on Oct. 24, 2017, Chinese Application No. 201711003630.4, filed on Oct. 24, 2017, and Chinese Application No. 201711003500.0, filed on Oct. 24, 2017, the entire contents of all of which are hereby incorporated by reference.

### FIELD OF THE DISCLOSURE

The present disclosure generally relates to the field of image processing technologies and, more particularly, relates to grating, stereoscopic 3D display device including the grating, and display method thereof.

### BACKGROUND

A naked-eye 3-dimensional (3D) display device or an autostereoscopic 3D display device often includes a display panel and a grating coupled to the display panel. To display a 3D image, the 3D image is first subjected to an image arrangement process, i.e., a left-eye image and a right-eye image of the 3D image are displayed on the display screen of the autostereoscopic 3D display device according to a certain rule. Meanwhile, based on the beam/light-splitting effect of the grating, the left-eye image and the right-eye image are sent to the user's left eye and right eye, respectively, enabling the user to observe the 3D image. Because the constraints of accessory equipment such as stereoscopic glasses are released, the viewing comfort of the autostereoscopic 3D display device is improved and the application field is widened. The autostereoscopic 3D display technology provides users with excellent 3D stereoscopic viewing experience and, thus, has received extensive attention.

Currently, most autostereoscopic 3D display devices are compatible with a 2D display mode and a 3D display mode. In the 2D display mode, the light-splitting effect of the existing grating may cause breakpoints or sawtooth in the displayed 2D image. For example, a jagged cut or the like may be formed in the displayed characters. Thus, to ensure a desired 2D/3D display effect, the autostereoscopic 3D display device often adopts a switchable grating, which is switched on in the 3D display mode to enter a light-splitting state, thereby sending the left-eye image and the right-eye image to the user's left eye and right eye, respectively, and enabling the user to watch the 3D image. The switchable grating is switched off in the 2D display mode, in which the grating is in a transparent state without a light-splitting effect, such that a 2D display is realized and a 2D image is observed by the user.

However, due to various limitations of the optical characteristics of the existing gratings, the autostereoscopic 3D display device compatible with the 2D/3D display mode may only achieve an excellent 3D display in a landscape screen orientation, but experience serious Moiré phenomenon in the 3D display in a portrait screen orientation, or only achieve an excellent 3D display in the portrait screen orientation, but experience serious Moiré phenomenon in the 3D display in the landscape screen orientation. That is, the existing autostereoscopic 3D display device compatible with the 2D/3D display mode is unable to realize excellent 3D display in both the landscape screen orientation and portrait screen orientation.

Thus, the existing autostereoscopic 3D display devices are often configured to perform the 3D display in only one screen orientation such as the landscape screen orientation, and to perform the 2D display only in the landscape screen orientation. However, as smart terminals are becoming more and more popular with increased applications, more and more application scenarios are desiring the 3D display in the portrait screen orientation. Thus, the 3D display in the portrait screen orientation gradually becomes an essential desire for the users.

To realize both the 3D display and the 2D display in each of the landscape screen orientation and the portrait screen orientation, a switchable dual-grating structure has been provided. That is, in the 3D display mode in the landscape screen orientation (i.e., in the landscape screen 3D display mode), one grating performs the light-splitting function, while in the 3D display mode in the portrait screen orientation (i.e., in the portrait screen 3D display mode), the other grating performs the light-splitting function. In the 2D display mode, to ensure the 2D display effect and suppress the breakpoints or sawtooth in the displayed 2D images, the two gratings are both switched off. However, the design of the switchable dual-grating structure is substantially complicated and the fabrication process is substantially difficult, and the switchable dual-grating structure also has a great influence on the weight and thickness of the 3D display device. Further, because the switchable dual-grating structure has to be switched between a switching-on state and the switching-off state, the display driving is very complicated.

The disclosed grating, stereoscopic 3D display device, and display method thereof are directed to solve one or more problems set forth above and other problems in the art.

### BRIEF SUMMARY OF THE DISCLOSURE

One aspect of the present disclosure provides a stereoscopic 3D display device compatible of a 2D display mode, a landscape screen 3D display mode and a portrait screen 3D display mode. The stereoscopic 3D display device comprises a display screen; and a grating arranged opposite to the display screen, wherein in each of the 2D display mode, the landscape screen 3D display mode and the portrait screen 3D display mode, the grating is in a light-splitting state. The grating includes a plurality of grating units arranged in parallel. A grating unit of the plurality of grating units is obliquely disposed with respect to a long side or a short side of the display screen, and an angle formed between the grating unit and the long side or the short side of the display screen is between 30° and 40°.

Another aspect of the present disclosure provides a display method for a stereoscopic 3D display device compatible of a 2D display mode, a landscape screen 3D display mode and a portrait screen 3D display mode, comprising: a display screen; and a grating arranged opposite to the display screen, wherein in each of the 2D display mode, the landscape screen 3D display mode and the portrait screen 3D display mode, the grating is in a light-splitting state, wherein: the grating includes a plurality of grating units arranged in parallel, a grating unit of the plurality of grating units is obliquely disposed with respect to a long side or a short side of the display screen, and an angle formed between the grating unit and the long side or the short side of the display screen is between 30° and 40°. The display method comprises: determining a current display mode of the stereoscopic 3D display device; after determining the stereoscopic 3D display device is in the 2D display mode, performing 2D display of to-be-displayed content; after determining the stereoscopic 3D display device is in the landscape screen 3D display mode, according to landscape screen grating parameters, performing landscape screen 3D display of the to-be-displayed content; and after determining the stereoscopic 3D display device is in the portrait screen 3D display mode, according to portrait screen grating parameters, performing portrait screen 3D display of the to-be-displayed content, wherein in each of the 2D display mode, the landscape screen 3D display mode and the portrait screen 3D display mode, the grating is in the light-splitting state.

Another aspect of the present disclosure provides a grating. The grating is applied to for a stereoscopic 3D display device compatible of a 2D display mode, a landscape screen 3D display mode and a portrait screen 3D display mode; in each of the 2D display mode, the landscape screen 3D display mode and the portrait screen 3D display mode, the grating is in a light-splitting state; the grating is a rectangle; the grating includes a plurality of grating units arranged in parallel; a grating unit of the plurality of grating units is obliquely disposed with respect to a long side or a short side of the rectangle; and an angle formed between the grating unit and the long side or the short side of the rectangle is between 30° and 40°.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of an exemplary stereoscopic 3D display device consistent with disclosed embodiments;

FIG. 2 illustrates a schematic diagram of an exemplary grating in an exemplary stereoscopic 3D display device in FIG. 1 consistent with disclosed embodiments;

FIG. 3 illustrates a schematic diagram of an exemplary display screen in an exemplary stereoscopic 3D display device in FIG. 1 consistent with disclosed embodiments;

FIG. 4a illustrates an image displayed by an existing stereoscopic 3D display device in a 2D display mode;

FIG. 4b illustrates an image displayed by an exemplary stereoscopic 3D display device in a 2D display mode consistent with disclosed embodiments;

FIG. 5 illustrates a schematic cross-sectional view of an exemplary UV LENS grating in an exemplary stereoscopic 3D display device in FIG. 1 consistent with disclosed embodiments;

FIG. 6 illustrates a schematic cross-sectional view of another exemplary UV LENS grating in an exemplary stereoscopic 3D display device in FIG. 1 consistent with disclosed embodiments;

FIG. 7 illustrates a schematic diagram of another exemplary stereoscopic 3D display device consistent with disclosed embodiments;

FIG. 8 illustrates a schematic diagram of an exemplary grating in a light-splitting state in another exemplary stereoscopic 3D display device in FIG. 7 consistent with disclosed embodiments;

FIG. 9 illustrates a schematic diagram of an exemplary grating in a landscape screen 3D display mode of another exemplary stereoscopic 3D display device in FIG. 7 consistent with disclosed embodiments;

FIG. 10 illustrates a schematic diagram of an exemplary grating in a portrait screen 3D display mode of another exemplary stereoscopic 3D display device in FIG. 7 consistent with disclosed embodiments;

FIG. 11 illustrates a schematic diagram of another exemplary stereoscopic 3D display device consistent with disclosed embodiments;

FIG. 12 illustrates a schematic diagram of another exemplary stereoscopic 3D display device consistent with disclosed embodiments;

FIG. 13 illustrates a schematic diagram of another exemplary stereoscopic 3D display device consistent with disclosed embodiments;

FIG. 14 illustrates a perspective view of an exemplary three-dimensional interface consistent with disclosed embodiments;

### DETAILED DESCRIPTION

Reference will now be made in detail to exemplary embodiments of the disclosure, which are illustrated in the accompanying drawings. Hereinafter, embodiments consistent with the disclosure will be described with reference to drawings. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure. Further, when no conflict exists, the exemplary features illustrated in various embodiments may be combined and/or rearranged. When no conflict exists, the exemplary features illustrated in various embodiments may be combined and/or rearranged.

First, it should be noted that, in the present disclosure, the term “single-layer” and “double-layer” in “single-layer grating” (i.e., a single grating)” and “double-layer grating (i.e., a double grating)” do not refer to the number of the layers of internal structure of the grating itself, instead, refers to the number of the layers of integral structures that can implement the function of the grating alone. In a stereoscopic 3D display device, when the grating is a single grating, only one grating structure that has a grating function, i.e., a light-splitting effect, is disposed in the stereoscopic 3D display device. Regardless of the display mode, the light splitting is achieved by the same grating structure. When the grating is a double grating, two grating structures which each has a grating function, i.e., a light-splitting effect, are disposed in the stereoscopic 3D display device, and in different display modes, the light splitting may be achieved by different grating structures.

For example, when the grating is a lenticular lens grating, the single-layer grating may be a single-refractive-index lens grating or a birefringence lens grating. The numbers of the layers of internal structure of the two gratings are different, the single-refractive-index lens grating corresponds to one layer of internal structure, and the birefringence lens grating corresponds to two layers of internal structures with different refractive index. The double-layer grating may include two stacked single-refractive-index lens gratings, two stacked birefringence lens gratings, or a single-refractive-index lens grating and a birefringence lens grating stacked together.

In addition, it should also be noted that, in the present disclosure, the term “landscape screen 3D display mode” and “portrait screen 3D display mode” refer to the landscape screen display and portrait screen display in the physical sense of the display screen, respectively. That is, when the display screen is arranged in a landscape orientation, the performed 3D display is in the landscape screen 3D display mode. When the display screen is in the portrait screen orientation, the performed 3D display is in the portrait screen 3D display mode. However, in each of the landscape and portrait screen 3D display modes, the displayed contents may be displayed horizontally or vertically, which is not limited by the present disclosure.

The present disclosure provides an improved grating, stereoscopic 3D display device, and display method thereof, which is compatible of three display modes, i.e., a 2D display mode, a landscape screen 3D display mode and a portrait screen 3D display mode. The structure and driving may be substantially simple, and the display effect of the three display modes may be ensured.

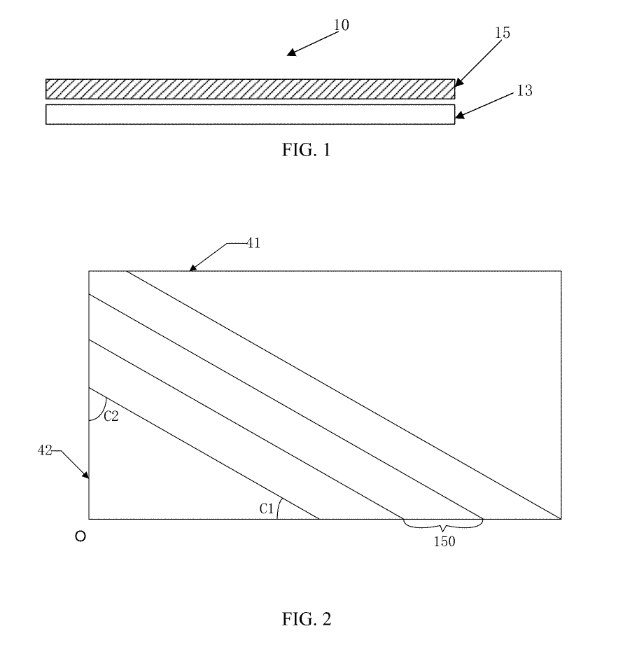

FIG. 1 illustrates a schematic diagram of an exemplary stereoscopic 3D display device consistent with disclosed embodiments. The stereoscopic 3D display device may be compatible of a 2D display compatible mode, a landscape screen 3D display mode and a portrait screen 3D display mode.

As shown in FIG. 1, the stereoscopic 3D display device may comprise a display screen 13 and a grating arranged opposite to the display screen 13. The display screen 13 may have various shape, such as a rectangular shape, a square shape, etc. The size and shape of the grating 15 may be matched with the size and shape of the display screen 13, receptively. In one embodiment, as shown in FIG. 1, the display screen 13 have a rectangular shape, and the size and shape of the grating 15 may be the same as the size and shape of the display screen 13, receptively.

In one embodiment, the grating 15 may be a single-layer grating, i.e., a single grating. A corresponding structure is shown in FIG. 2. FIG. 2 illustrates a schematic diagram of an exemplary grating in an exemplary stereoscopic 3D display device in FIG. 1 consistent with disclosed embodiments.

As shown in FIG. 2, the grating 15 may include a plurality of grating units 150 arranged in parallel. The grating unit 150 may be obliquely disposed with respect to the long side 41 of the display screen 13, and an angle C1 formed between the grating unit 150 and the long side 41 of the display screen 13 may be approximately between 30° and 40°. In another embodiment, the grating unit 150 may be disposed obliquely with respect to the short side m of the display screen 13, and an angle C1 formed between the grating unit 150 and the short side 42 of the display screen 13 may be approximately between 30° and 40°.

In particular, the angle C1 and C2 may be any angle between 30° and 40°, which is not limited by the present disclosure. For example, the angle C1 between the grating unit 150 and the long side 41 of the display screen 13 may be 35°, or the angle C2 between the grating unit 150 and the short edge 42 of the of the display screen 13 may be 35°.

In the 2D display mode, the landscape screen 3D display mode, and the portrait screen 3D display mode, the grating 15 may be always in the light-splitting state. The disclosed stereoscopic 3D display device may be an autostereoscopic 3D display device due to the light-splitting effect of the grating.

Because the grating 15 has the size and shape matched with the display screen 13, the long side of the display screen 13 may be parallel to the long side of the grating 15, and the short side of the display screen 13 may be also parallel to the short side of the grating 15. In one embodiment, the angle between the grating unit 150 and the long side of the grating 15 may be approximately between 30° and 40°. In another embodiment, the angle between the grating unit 15 and the short side of the grating 15 may be approximately between 30° and 40°.

The long side and the short side are two different boundaries or edges, and the length of the long side is longer than the length of the short side. When the display screen 13 has a square shape, the long side and the short side have the same length, and the long side and the short side respectively refer to two adjacent sides of the square. The grating unit 150 may be obliquely disposed with respect to the boundaries of the display screen 13, and the angle between one side of the two adjacent sides of the display screen 13 and the grating unit 150 may be approximately between 30° to 40°.

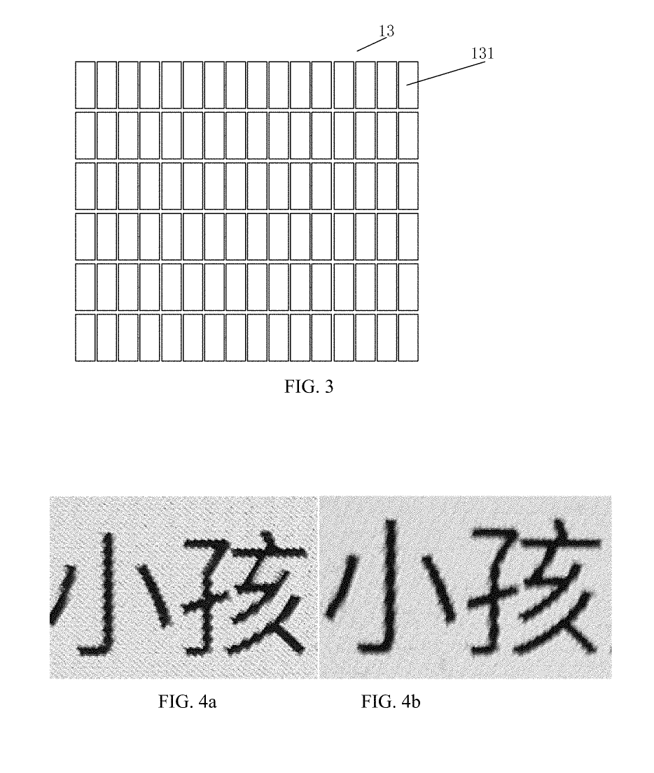

FIG. 3 illustrates a schematic diagram of an exemplary display screen in an exemplary stereoscopic 3D display device in FIG. 1 consistent with disclosed embodiments. As shown in FIG. 3, the display screen 13 may include a plurality of display units 131, i.e., pixel units, arranged in a matrix. The pixel density of the display screen 13 may be above 300 PPI.

The grating 15 may be disposed on the light exit side or the light incident side of the display screen 13. In one embodiment, the grating 15 may be a solid state stationary grating, i.e., the grating 15 may not be switched-on (i.e., activated) and switched-off (i.e., deactivated), and the original state of the grating 15 may be a light-splitting state including the grating units 150. The grating units 150 may be always physically existing at the above-mentioned angle (i.e., the angle between the grating unit 15 and the short/long side of the grating 15 may be approximately between 30° and 40°). That is, without switching-on and switching-off the grating 15 and regardless of any display modes of the stereoscopic 3D display device, the grating 15 may be always in the light-splitting state.

In another embodiment, the grating 15 may be a switchable grating capable of being switched on and switched off. The original state of the grating 15 may be a light-transmitting state or light-transparent state without any grating units. The grating 15 may be driven, for example, electrically driven to be switched on to form the grating units 150 with the above-mentioned angle, such that the grating 15 enters the light-splitting state.

That is, when the stereoscopic 3D display device is in each of the 2D display mode, the landscape screen 3D display mode and portrait screen 3D display mode, the grating 15 may be always switched on having the light-splitting state. After the grating 15 is switched off, the grating 15 may enter the light-transmitting state in which the grating units 150 all disappear.

In the disclosed embodiments, the grating unit 150 may be obliquely disposed with respect to the long side 41 of the display screen 13, and an angle C1 formed between the grating unit 150 and the long side 41 of the display screen 13 may be approximately between 30° and 40°, or the grating unit 150 may be disposed obliquely with respect to the short side 42 of the display screen 13, and an angle C1 formed between the grating unit 150 and the short side 42 of the display screen 13 may be approximately between 30° and 40°.

Through configuring the angle C1 or angle C2 to be approximately between 30° and 40°, in the landscape screen 3D display mode, the grating 15 may split the light incident onto the grating, and left-eye and right-eye images of the 3D image may be arranged based on the grating parameters in the landscape screen 3D display mode, such as the grating tilt angle (i.e., the titled angle of the grating, which is related to the above angle C1 or angle C2), the grating period (i.e., the horizontal width of the grating unit in the landscape screen 3D display mode), the horizontal displacement of the grating (i.e., the horizontal distance between the starting point of the grating and an original point in the landscape screen 3D display mode, for illustrative purposes, the left bottom corner point O of the display screen 13 in the landscape screen 3D display mode shown in FIG. 2 is defined as the original point, and the starting point of the grating is a point on the long side of the grating in which the point has the shortest distance to the original point), then the 3D image may be displayed in the landscape screen 3D display mode.

In addition, in the portrait screen 3D display mode, the grating 15 may split the light incident onto the grating, and left-eye and right-eye images of the 3D image may be arranged based on the grating parameters in the portrait screen 3D display mode, such as the grating tilt angle (i.e., the titled angle of the grating, which is related to the above angle C1 or angle C2), the grating period (i.e., the horizontal width of the grating unit in the portrait screen 3D display mode), the horizontal displacement of the grating (i.e., the horizontal distance between the starting point of the grating and the original point of the grating in the portrait screen 3D display mode, the starting point of the grating is a point on the short side of the grating in which the point has the shortest distance to the original point), then the 3D image may be displayed.

Through configuring the angle C1 or angle C2 to be approximately between 30° and 40°, the Moiré pattern appearing in both the landscape screen 3D display and portrait screen 3D display may be significantly suppressed, and the stereoscopic 3D display performance may be improved in both the landscape screen 3D display mode and portrait screen 3D display mode. Accordingly, the stereoscopic 3D display device including the grating may be able to realize 3D display in both the portrait and landscape screen orientations, and provide an improved stereoscopic 3D display effect in both the portrait and landscape screen orientations.

In the 2D display mode, the 2D display may be also preformed when the grating 15 is in the light-splitting state. However, through configuring the angle C1 or angle C2 to be approximately between 30° and 40°, the occurrence of breakpoints and jagged edges in the displayed characters or images may be significantly weakened, and the 2D display performance may be improved. Corresponding displayed 2D images when the grating 15 is in the light-splitting state are shown in FIGS. 4a-4b.

FIG. 4a illustrates an image displayed by an existing stereoscopic 3D display device in a 2D display mode, and FIG. 4b illustrates an image displayed by an exemplary stereoscopic 3D display device in a 2D display mode consistent with disclosed embodiments. As shown in FIG. 4 a, the character “ [symbol] ” (child in English) displayed by the existing stereoscopic 3D display device in the 2D display mode shows obvious jagged edges, and the text display performance is substantially poor. As a comparison, the character “ [symbol] ” (child in English) displayed by the disclosed stereoscopic 3D display device in the 2D display mode shows weakened jagged edges, and the text display performance is significantly improved.

In the disclosed embodiments, the stereoscopic 3D display device may have the following features.

First, through configuring the tilt angle of the grating unit to be approximately between 30° and 40°, the 3D display in both the landscape screen 3D display mode and portrait screen 3D display mode (i.e., both the landscape screen 3D display and portrait screen 3D display) may be realized by a single grating (i.e., the same grating), the Moiré pattern appearing in the 3D display in both the landscape screen 3D display and portrait screen 3D display may be significantly suppressed, and the stereoscopic 3D display performance of both the landscape screen 3D display and portrait screen 3D display may be improved.

Second, the 2D display mode may be performed when the grating is in the light-splitting state, through configuring the tilt angle of the grating unit to be approximately between 30° and 40°, the occurrence of breakpoints and jagged edges in the displayed images (such as characters) may be significantly weakened, and the 2D display performance may be improved.

Third, because the grating may be always switched on when the stereoscopic 3D display device is in each of the 2D display mode, the landscape screen 3D display mode and portrait screen 3D display mode, a 2D/3D fusion display may be realized, i.e., the 2D display and the 3D display mode may be fused and displayed on one display interface, and the 3D display may appear in any shapes at any positions on the display screen.

Fourth, a single-grating structure/a single grating may be able to realize 2D display mode/landscape screen 3D display mode/portrait screen 3D display mode compatible, the structure of the stereoscopic 3D display device may be substantially simple, and the manufacturing process flow may be simplified.

Fifth, in each of the 2D display mode, the landscape screen 3D display mode and portrait screen 3D display mode, the grating may be always switched on to maintain the light-splitting state without switching-on and switching-off. Thus, the display driving may be simple. When a solid state stationary grating is used as the grating, the grating driving and the grating switching may be no longer involved. Thus, the display control may be simple and efficient, and the power consumption of the stereoscopic 3D display device may be reduced.

Last but not at least, the stereoscopic 3D display device including the grating may have a thin thickness, a small volume, a low cost and improved display performance.

In certain embodiments, the grating 15 may be a lens grating, which may include a cylindrical lens grating or a liquid crystal lens grating. In one embodiment, the grating 15 may be a UV-LENS lens grating. The UV-LENS lens grating may be a stationary grating, which may maintain the light-splitting state in the stereoscopic 3D display device without being switched-on and switched-off. The UV-LENS lens grating may be made by curing a UV-curable resin cured under UV light.

UV-curable resin is a kind of resin added with photo-initiator (or photosensitizer). After absorbing high-intensity UV light emitted from a UV light curing equipment, the UV-curable resin produces active free radicals or ion radicals, which leads to polymerization, cross-linking, and grafting. Thus, the UV-curable resin (such as UV coating, ink, adhesive, etc.) is converted from liquid to solid within couple seconds. The UV adhesive structural resin may include a resin material produced by polymerization or copolymerization of other heterocyclic compounds, such as unsaturated polyester resin, polyacrylic acid acrylate, epoxy acrylate, urethane acrylate, and cationic curing base resin, etc.

When the grating 15 is a UV-LENS lens grating, in a direction perpendicular to the extending direction of the grating unit 150, the cross-section of the grating unit 150 may have a circular arc shape, a sawtooth shape, or a bowl shape, which is not limited by the present disclosure.

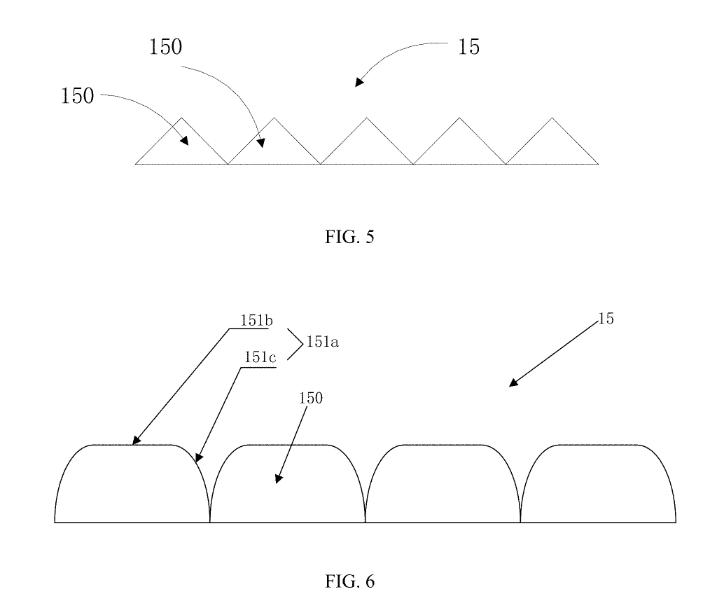

FIG. 5 illustrates a schematic cross-sectional view of an exemplary UV LENS grating in an exemplary stereoscopic 3D display device in FIG. 1 consistent with disclosed embodiments. As shown in FIG. 5, the UV-LENS lens grating 15 may include a plurality of grating units 150 arranged in parallel. The cross-section of the grating unit 150 may have a sawtooth shape. Here, the sawtooth shape may be a triangle shape, a trapezoidal shape or other appropriate polygonal shape. The shape of the cross-section of the grating unit 150 may be symmetrical about the perpendicular bisector of the cross-section of the grating unit 150, thereby ensuring the light-splitting effect of the grating. In one embodiment, gaps may not be disposed between two adjacent grating units 150, such that the light leakage may be prevented between adjacent grating units 150.

FIG. 6 illustrates a schematic cross-sectional view of another exemplary UV LENS grating in an exemplary stereoscopic 3D display device in FIG. 1 consistent with disclosed embodiments. As shown in FIG. 6, the UV-LENS lens grating 15 may include a plurality of grating units 150. In a direction perpendicular to the extending direction of the grating unit 150, the cross-section of the grating unit 150 may have a bowl shape, and a light exit surface 151a of the grating unit 150 may include a platform portion 151b corresponding to the bottom of the bowl shape and a curved portion 151c located on both sides of the platform portion 151b.

In one embodiment, the ratio of the area of the platform portion 151b to the area of the light exit surface 151a of the grating unit 150 may be less than ½. That is, the area of the platform portion 151b may account for less than 50% of the area of the light exit surface 151a of the entire grating unit 15. Thus, both the landscape screen 3D display and portrait screen 3D display may be realized and, meanwhile, the occurrence of breakpoints and jagged edges in the displayed 2D images (such as characters) may be further suppressed in the 2D display mode.

In one embodiment, the UV-LENS lens grating 15 may be attached to the light exit side of the display screen 13. The UV-LENS lens grating 15 and the display screen 13 may be directly attached to each other through, for example, an optical adhesive. The UV-LENS lens grating has a bottom surface facing the display screen and an opposing top surface far away from the display screen 13. To facilitate the attachment between the UV-LENS lens grating 15 and the display screen 13, a back adhesive may be provided on the bottom surface of the UV-LENS lens grating 15, and the UV-LENS lens grating 15 may be attached to the display screen 13 through the back adhesive.

In another embodiment, a polarizer may be disposed between the UV-LENS lens grating 15 and the display screen 13, and the UV-LENS lens grating 15 may be attached to the polarizer through the optical adhesive or the back adhesive provided on the bottom surface of the UV-LENS lens grating 15. In one embodiment, the UV-LENS lens grating 15 and the polarizer may be integrally formed, i.e., integrated, to facilitate the assembly of the stereoscopic 3D display device. In another embodiment, the polarizer may be integrated with the display screen 13.

In certain other embodiments, the grating 15 may be a slit grating, which may be a non-switchable stationary slit grating or a switchable dynamic slit grating. The stationary slit grating may include, for example, a metal slit grating or a black matrix (BM) slit grating, and the dynamic slit grating may include, for example, a liquid crystal slit grating. In one embodiment, when the grating 15 is a slit grating, an aperture ratio of the slit grating may be configured to be between 30% and 45%, such that a stereoscopic 3D display device including the slit grating may be able to realize both the landscape screen 3D display and portrait screen 3D display and, meanwhile, realize the 2D display mode when the grating is in the light-splitting state with weakened jagged edges in the displayed 2D images (such as characters) in the 2D display mode.

In addition, through configuring the aperture ratio to be between 30% to 45%, the display brightness may be ensured. The above-mentioned aperture ratio refers to a proportion of the light-transmitting portion of a single-grating unit of the slit grating in the entire single-grating unit, i.e., a ratio between the light-transmitting portion of a single-grating unit of the slit grating and the entire single-grating unit.

When the grating 15 is a slit grating, the grating 15 may be disposed on the light exit side or the light incident side of the display screen 13. When the grating 15 is a lens grating, the grating 15 may be disposed on the light exit side of the display screen 13.

For example, when the grating 15 is a liquid crystal slit grating, in one embodiment, the grating 15 may be disposed on the light exit side of the display screen 13, and a polarizer may be disposed between the liquid crystal slit grating 15 and the display screen 13. In another embodiment, the liquid crystal slit grating 15 may be disposed on the light incident side of the display screen 13. The liquid crystal slit grating 15 may have a top surface facing the display screen 13 and a bottom surface far away from the display screen 13. To ensure the light transmittance, when disposing the liquid crystal slit grating 15 on the light incident side of the display screen 13, a brightness enhancement polarizer may be disposed on the bottom surface of the liquid crystal slit grating to increase the brightness.

In addition, the grating 15 may maintain in the light-splitting state without being switched on and off in each of the 2D display mode, the landscape screen 3D display mode and portrait screen 3D display mode, such that from the perspective of the display driving control, the display driving control may be substantially simple. In another embodiment, when the stereoscopic 3D display device is in the 2D display mode and the grating 15 is a dynamic slit grating such as a liquid crystal slit grating, the grating 15 may be configured to be in the switched-off state instead of the switched-on state (i.e., the light-splitting state). Because the grating units are not formed in the grating, the edges of the displayed 2D display content (for example, characters, images, etc.) may not be cut to form jagged edges, thereby ensuring a good 2D display performance.

Further, regardless of the landscape screen 3D display and portrait screen 3D display, the light-splitting function of the grating may be always desired. In the disclosed stereoscopic 3D display device, the grating 15 may also perform the 2D display in the light-splitting state with a desired 2D display effect. The disclosed stereoscopic 3D display device may also be compatible with the 2D/3D fusion display mode, in which 3D images and 2D images may be simultaneous displayed. For example, multiple windows may be simultaneously displayed, certain windows may display 3D images in the 3D display mode (the landscape screen 3D display mode or the portrait screen 3D display mode), while certain other windows may display the 2D images in the 2D display mode. In the 2D/3D fusion display mode, the grating 15 may be in the light-splitting state.

In one embodiment, the angle C1 between the grating unit 150 and the long edge 41 of the display screen 13 may be configured to be approximately 35° or the angle C2 between the grating unit 150 and the short edge 42 of the display screen 13 may be configured to be approximately 35°, through which jagged edges of the images displayed in the 2D display mode, may be suppressed. Further, when entering the landscape screen 3D display mode and portrait screen 3D display mode given C1 or C2=35°, the Moiré pattern may be further eliminated and the 3D display effect may be further improved.

As long as the angle between the grating unit 150 and the long side 41/short side 42 of the display screen 13 are approximately between 30° and 40°, such as 30°, 33°, 35°, 38°, 40°, the present disclosure does not limit the specific value of the angle.

The disclosed stereoscopic 3D display device may be any appropriate device having a display function such as a mobile phone, a Pad, a notebook computer, a display, and a gaming device, etc.

FIG. 7 illustrates a schematic diagram of another exemplary stereoscopic 3D display device consistent with disclosed embodiments. As shown in FIG. 7, the stereoscopic 3D display device 10 may include a cover plate 11, a first optical adhesive layer 12, a display screen (such as a touch control display screen) 13, a second optical adhesive layer 14, a grating 15, and a backlight module 16.

In one embodiment, the cover plate 11 may be a tempered glass cover plate 11, i.e., the cover plate 11 may be made of tempered glass. When the tempered glass is damaged by external forces, the debris will form honeycomb-like obtuse-angled small particles, which are not likely to cause serious damage to the human body. The impact strength of tempered glass of the same thickness is 3 to 5 times that of ordinary glass, and the flexural strength is 3 to 5 times that of ordinary glass. The tempered glass has good thermal stability, and is able to withstand a temperature difference 3 times that of ordinary glass, and a temperature change of 300° C., thereby providing enhanced protection to the users.

The first optical adhesive layer 12 may be disposed between the cover plate 11 and the touch control display screen 13, to bond the cover plate 11 to the touch control display screen 13. The first optical adhesive layer 12 may increase the contrast ratio of the touch control display screen 13, reduce the glare and the loss of light emitted from the touch control display screen 13, increase the brightness of the touch control display screen 13, provide the high transmittance, and reduce the energy consumption.

Before being attached between the cover plate and the display screen, the first optical adhesive layer may include an acrylic substrate and releasing films disposed on both sides of the acrylic substrate. After being attached between the cover plate and the display screen, the releasing films disposed on both sides of the acrylic substrate may be removed. As long as the first optical adhesive layer 12 is able to attach the cover plate 11 to the touch control display screen 13, the material and structure of the first optical adhesive layer are not specifically limited by the present disclosure.

The first optical adhesive layer 12 may have a first side facing the cover plate 11 and an opposing second side far away from the cover plate 11, and the touch control display screen 13 may be disposed on the second side of the first optical adhesive layer 12. Meanwhile, the touch control display screen 13 may be disposed between the first optical adhesive layer 12 and the second optical adhesive layer 14. The touch control display screen 13 may be a capacitive-type touch control display screen 13, a resistive-type touch control display screen 13, or a surface acoustic wave-type touch control display screen 13, which is not limited by the present disclosure.

The second optical adhesive layer 14 may be disposed between the touch control display screen 13 and the grating 15, and may be connected to both the touch control display screen 13 and the grating 15. In one embodiment, the structure of the second optical adhesive layer 14 and the first optical adhesive layer 12 may be the same, and in another embodiment, the structure of the second optical adhesive layer 14 and the first optical adhesive layer 12 may be different. In certain embodiments, the first optical adhesive layer 12 and the second optical adhesive layer 14 may also be omitted as long as the cover plate 11, the display screen 13, and the grating 15 are relatively fixed. For example, the cover plate 11, the display screen 13 and the grating 15 may be directly stacked together without any optical adhesive layers.

The grating 15 may have a first side facing the second optical adhesive layer 14 and an opposing second side far away from the second optical adhesive layer 14, and the backlight module 16 may be disposed on the second side of the grating 15. The backlight module 16 may provide the touch control display screen 13 with a light source having sufficient brightness and uniform distribution, enabling the touch control display screen 13 to display images.

In one embodiment, as shown in FIG. 7, the grating 15 may be a slit grating, which may be disposed on the light incident side of the display screen 13. The grating 15 may be, for example, a liquid crystal slit grating, a metal slit grating, or a black matrix slit grating.

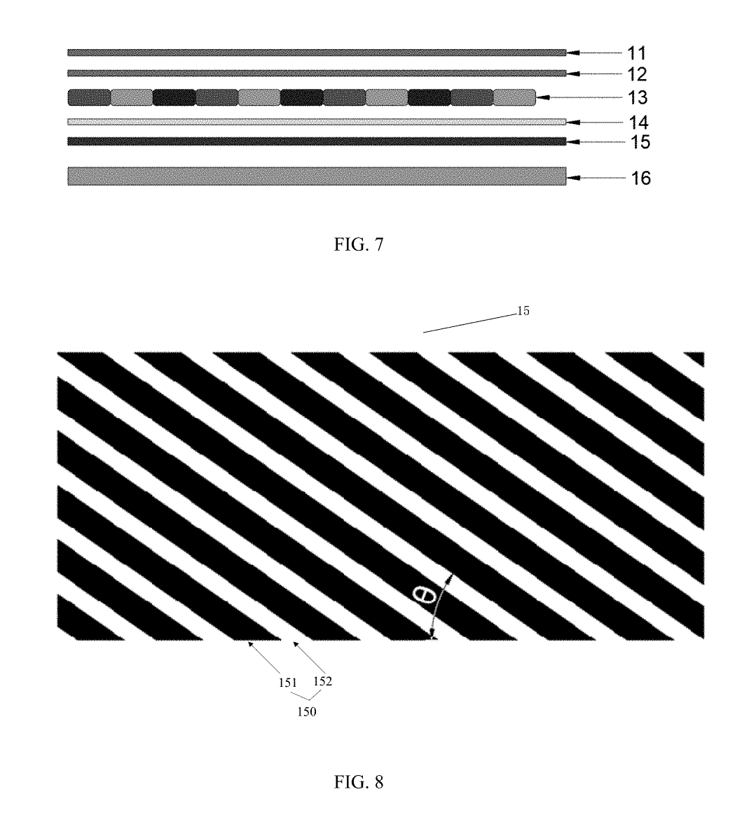

FIG. 8 illustrates a schematic diagram of an exemplary grating in a light-splitting state in another exemplary stereoscopic 3D display device in FIG. 7 consistent with disclosed embodiments. As shown in FIG. 8, the grating 15 may have a rectangular shape. When the grating 15 is in a light-splitting state, the grating 15 may include a plurality of grating units 150 arranged in parallel. Each of the grating units 150 may include a light-shielding portion 151 and a light-transmitting portion 152.

In one embodiment, the light-splitting state may be the original state of the grating 15. In another embodiment, the light-splitting state may be a state formed after the grating in the original light-transmitting state is driven to form the grating units 150. The grating unit 150 may be disposed obliquely, and the grating tile angle θ (i.e., C1) may be approximately between 30° and 40°. That is, the angle between the grating unit 150 and the long side of the display screen 13 or the long side of the grating 15 may be approximately between 30° and 40°.

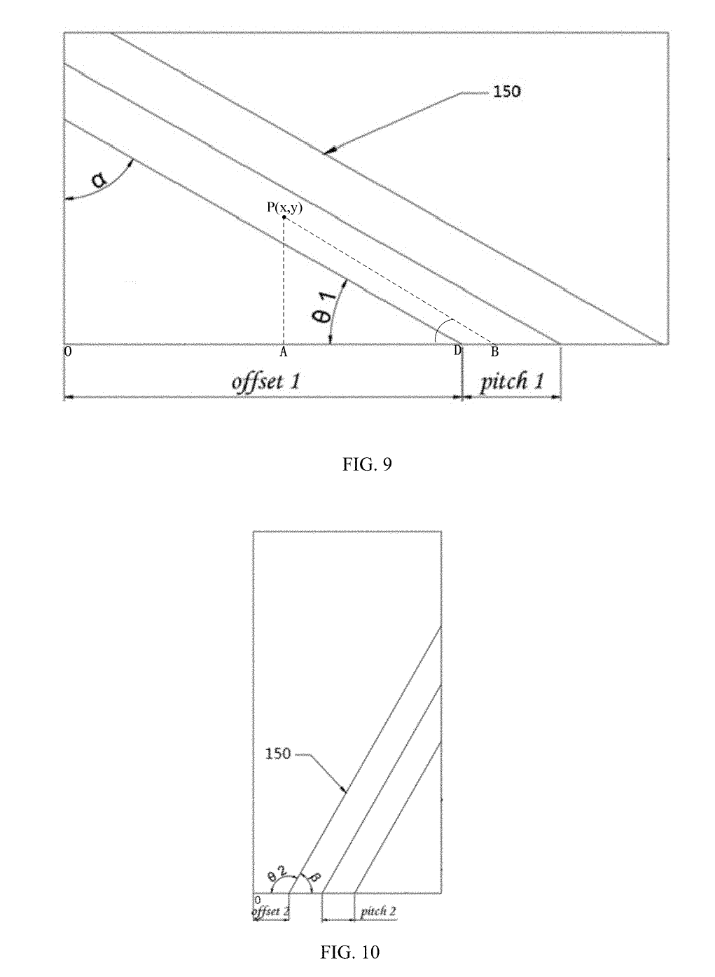

FIG. 9 illustrates a schematic diagram of an exemplary grating in a landscape screen 3D display mode of another exemplary stereoscopic 3D display device in FIG. 7 consistent with disclosed embodiments.

As shown in FIG. 9, the grating 15 may be in the light-splitting state, the grating tile angle (the angle between the grating unit 150 and the long side of the display screen 13 or the long side of the grating 15) θ1=0, which may be approximately between 30° and 40°. The angle between the grating unit 150 and the short side of the display screen 13 is α, and α and θ1 may be complementary angle, i.e., α+θ1=90°. The value of the angle α may be approximately between 50° and 60°. Pitch1 is a grating period in the landscape screen orientation, which represents the horizontal width of the grating unit 150 when the display device is in the landscape screen orientation, i.e., the width of an individual grating unit 150 in the direction of the long side of the display screen. Offset1 represents the horizontal grating displacement of the grating 15 and, more particular, the amount of displacement of the grating unit in the horizontal direction, i.e., the horizontal distance between the starting point D of the grating and the original point O of the grating. For illustrative purposes, the left bottom corner point O of the display screen 13 is defined as the original point, for the sub-pixel P(x,y) on the display screen 13, the starting point of the grating may be a point on the long side of the grating in which the point has the shortest distance to the original point. In another embodiment, any appropriate point of the display screen 13 may be defined as the original point, and for the sub-pixel P(x,y) on the display screen 13, the starting point of the grating may be a point on the long side of the grating in which the point has the shortest distance to the original point.

In the landscape screen 3D display mode, these parameters (θ1, Pitch1 and offset1) will be used as the landscape screen grating parameters in the image arrangement algorithm of the 3D display.

In the landscape screen 3D display mode, the 3D image, i.e., the left-eye image and the right-eye image, may be arranged on the display screen 13 according to the landscape screen grating parameters. For illustrative purposes, provided that the left bottom corner point O of the display screen 13 is the original point, for the sub-pixel P(x,y) on the display screen 13, the position index of P may be first calculated by the following equation:

index=(x+y*cot(θ1)−offset1)/pitch1,

where index represents the position index of the sub-pixel P, and x and y represent the horizontal and vertical coordinates of the pixel of the sub-pixel P, respectively.

Referring to FIG. 9, the length of the line segment DB=the length of the line segment OA+the length of the line segment AB−the length of the line segment OD, the length of the line segment OA=x, the length of the line segment AB=y*cot (θ1), the length of the line segment OD=offset1, then the length of the DB (referred to as DB)=x+y*cot (θ1)−offset1, then index=DB/pitch1.

Then, according to the position index of each sub-pixel and the value of pitch/2, the pixel value subpixel (also called as the color value subpixel) of the sub-pixel P may be determined as the pixel value of the sub-pixel which has the position coordinate (x, y) in the left-eye image in the 3D image or the right-eye image in the 3D image

$$subpixel = \{ \begin{matrix}left [ x , y ] , & index < \frac{pitch}{2} \\ right [ x , y ] , & index \geq \frac{pitch}{2}\end{matrix} .$$

Here pitch is a grating period in the landscape screen orientation, which represents the horizontal width of the grating unit 150 when the display device is in the landscape screen orientation, i.e., the width of an individual grating unit 150 in the direction of the long side of the display screen.

That is, when index<pitch/2, the pixel value of P point may be displayed as the pixel value of sub-pixel (x,y) in the left-eye image, and when indexpitch/2, the pixel value of P point may be displayed as the pixel value of the sub-pixel (x, y) in the right-eye image, thereby realizing the landscape screen 3D display.

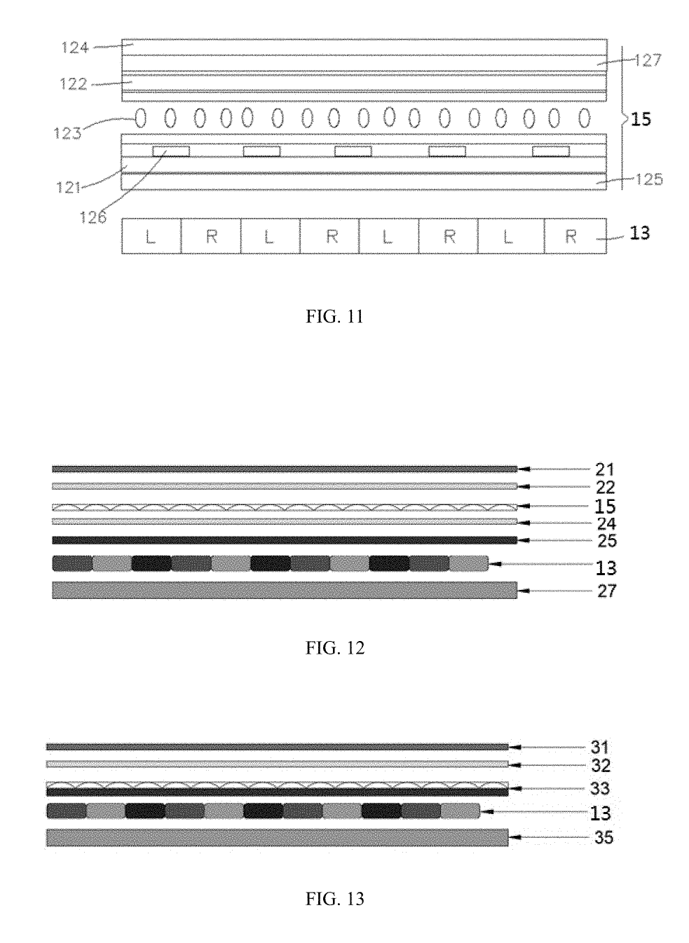

FIG. 10 illustrates a schematic diagram of an exemplary grating in a portrait screen 3D display mode of another exemplary stereoscopic 3D display device in FIG. 7 consistent with disclosed embodiments.

As shown in FIG. 10, the grating 15 may be in the light-splitting state, the grating tile angle (the angle between the grating unit 150 and the long side of the display screen 13 or the long side of the grating 15) is 02. The angle between the grating unit 150 and the short side of the display screen 13 is β, and the value of β may be equal to the value of the angle α in FIG. 9. Then the grating tile angle θ2=180°−β=180°−α=90°±θ, offset2 represents the grating displacement in the portrait screen orientation, and pitch2 represents the grating period in the portrait screen orientation. In particular, Offset2 represents the horizontal grating displacement of the grating 15 in the portrait screen orientation and, more particular, the amount of displacement of the grating unit in the horizontal direction, i.e., the horizontal distance between the starting point D of the grating and the original point O of the grating. For illustrative purposes, the left bottom corner point O of the display screen 13 in the portrait screen orientation is the original point, for the sub-pixel P(x,y) on the display screen 13, the starting point of the grating may be a point on the short side of the grating in which the point has the shortest distance to the original point. These parameters (θ2, pitch2, and offset2) will be used as the portrait screen grating parameters in the image arrangement algorithm of the 3D display.

Similar to the landscape screen 3D display, the left-bottom corner O of the display screen 13 is used as the original point. First, the position index index of each sub-pixel on the display screen 13 is calculated by the following equation:

index=(x+y*cot(θ2)−offset2)/pitch2,

where index represents the position index of a certain sub-pixel, and x and y respectively represent the horizontal and vertical coordinates of the sub-pixel. The principle may be similar to that of the landscape screen 3D display, which will not be repeated here.

Then, according to the position index index of each sub-pixel and the value of pitch/2, the pixel value (also called as the color value) subpixel of the sub-pixel P may be determined as the pixel value of the sub-pixel which has the position coordinate (x, y) in the left-eye image in the 3D image or the right-eye image in the 3D image

$$subpixel = \{ \begin{matrix}left [ x , y ] , & index < \frac{pitch}{2} \\ right [ x , y ] , & index \geq \frac{pitch}{2}\end{matrix} .$$

Here pitch is a grating period in the portrait screen orientation, which represents the horizontal width of the grating unit 150 when the display device is in the portrait screen orientation, i.e., the width of an individual grating unit 150 in the direction of the short side of the display screen.

That is, when index<pitch/2, the pixel value of P point may be displayed as the pixel value of sub-pixel (x,y) in the left-eye image, and when indexpitch/2, the pixel value of P point may be displayed as the pixel value of the sub-pixel (x, y) in the right-eye image, thereby realizing the portrait screen 3D display.

In summary, regardless of whether the stereoscopic 3D display device is in the landscape screen 3D display mode or portrait screen 3D display mode. For illustrative purposes, provided that the lower left corner of the display screen serves as the original point of the coordinate system, and the position index of each sub-pixel of the display screen may be obtained by the following equation:

index=(x+y*cot(θ12)−offset)/pitch,

where index represents the position index of a certain sub-pixel, x and y respectively represent the horizontal and vertical coordinates of the sub-pixel. θ12 represents the grating tilt angle in the current stereoscopic 3D display orientation (landscape or portrait), i.e., the angle between the grating unit and the bottom edge of the current stereoscopic display screen. That is, in the landscape screen stereoscopic 3D display, the bottom edge of the current stereoscopic display screen may be the long side of the display screen, and in the portrait screen stereoscopic 3D display, the bottom edge of the current stereoscopic display screen may be the short side of the display screen. offset represents the horizontal displacement of the grating in the current stereoscopic 3D display orientation, and pitch represents the period of the grating in the current stereoscopic 3D display orientation.

Then, according to the position index index of each sub-pixel and the value of pitch/2, the pixel value subpixel of the sub-pixel P may be determined as the pixel value of the sub-pixel which has the position coordinate (x, y) in the left-eye image in the 3D image or the right-eye image in the 3D image

$$subpixel = \{ \begin{matrix}left [ x , y ] , & index < \frac{pitch}{2} \\ right [ x , y ] , & index \geq \frac{pitch}{2}\end{matrix} .$$

Here pitch is a grating period in the landscape screen orientation or the portrait screen orientation. When the display device is in the landscape screen orientation, pitch represents the horizontal width of the grating unit 150 when the display device is in the landscape screen orientation, i.e., the width of an individual grating unit 150 in the direction of the long side of the display screen. When the display device is in the portrait screen orientation, pitch represents the horizontal width of the grating unit 150 when the display device is in the portrait screen orientation, i.e., the width of an individual grating unit 150 in the direction of the short side of the display screen.

The above-mentioned display method of realizing the landscape screen stereoscopic 3D display and portrait screen stereoscopic 3D display are only for illustrative purposes, and are not intended to limit the scope of the present disclosure. Those skilled in the art may establish different coordinate systems, and do calculations based on different coordinate origins and trigonometric functions to realize the landscape screen stereoscopic 3D display and portrait screen stereoscopic 3D display, which is not limited by the present disclosure.

In the 2D display mode, the grating 15 may also in the light-splitting state, which may ensure a desired 2D display performance and, meanwhile, weaken the occurrence of breakpoints and jagged edges in the displayed 2D images or characters) in the 2D display mode.

In certain embodiments, the grating unit 150 may be obliquely disposed with respect to the long side of the display screen 13, and the angle θ formed between the grating unit 150 and the long side of the display screen 13 may be approximately between 30° and 40°. Thus, the stereoscopic 3D display device including the grating may be able to realize 3D display in both portrait and landscape screen orientations and, meanwhile, reduce the Moiré pattern appearing in the 3D display. Meanwhile, in the 2D display mode, the stereoscopic 3D display device including the grating may be able to weaken the occurrence of breakpoints and jagged edges in the displayed 2D characters or images.

In certain other embodiments, the grating unit 150 may be obliquely disposed with respect to the short side of the display screen 13, and the angle θ formed between the grating unit 150 and the short side of the display screen 13 may be approximately between 30° and 40°. The display effect of the stereoscopic 3D display device including the grating may be similar to the display effect of the stereoscopic 3D display device including the grating, in which the grating unit 150 is obliquely disposed with respect to the long side of the display screen 13, and the angle θ formed between the grating unit 150 and the long side of the display screen 13 is approximately between 30° and 40°. The details are not repeated here.

In the disclosed embodiments, through configuring the tilt angle of the grating unit to be approximately between 30° and 40°, both the landscape screen 3D display and portrait screen 3D display may be realized by a single-grating (i.e., the same grating), and the Moiré pattern appearing in the 3D display in both the landscape screen 3D display and portrait screen 3D display may be significantly suppressed, thereby improving the stereoscopic 3D display performance in both the landscape screen 3D display mode and portrait screen 3D display mode.

Meanwhile, in the 2D display mode, the 2D display may be realized when the grating 15 is in the light-splitting state. The occurrence of breakpoints and jagged edges in the displayed images (such as characters) may be significantly weakened, and the 2D display performance may be improved. Because the grating 15 may be always switched on when the stereoscopic 3D display device is in each of the 2D display mode, the landscape screen 3D display mode and portrait screen 3D display mode, a 2D/3D fusion display may be realized, i.e., the 2D display and the 3D display mode may be fused and displayed on a single display interface, and the 3D display may appear in any shapes at any positions on the display screen.

In addition, a single-grating structure may be able to realize 2D display mode/landscape screen 3D display mode/portrait screen 3D display mode compatible, such that the structure of the stereoscopic 3D display device may be simple, the manufacturing process may be simplified, the volume may be small, the cost may be low, while the display performance may be improved. In each of the 2D display mode, the landscape screen 3D display mode and portrait screen 3D display mode, the grating 15 may be always switched on to maintain in the light-splitting state without switching-on and switching-off. Thus, the display control may be simple and efficient, and the power consumption of the stereoscopic display device may be reduced.

In another embodiment, from bottom to top, the stacked structure of the disclosed stereoscopic 3D display device may sequentially include a backlight module, a first polarizer, a slit grating (e.g., a liquid crystal slit grating or a solid state slit grating, etc.), a second polarizer (a polarizer shared by the touch control display screen and the slit grating), a touch control display screen, a third polarizer, and a glass cover plate. The above-mentioned components may be bonded with an optical adhesive, and the first polarizer may be APCF polarizer (i.e., a brightness enhancement polarizer) which increases the output light of the stereoscopic 3D display device.

In another embodiment, from bottom to top, the stacked structure of the disclosed stereoscopic 3D display device may sequentially include a backlight module, a first polarizer, a touch control display screen, a second polarizer (shared polarizer), a liquid crystal slit grating, a third polarizer and a glass cover plate, in which adjacent components may be attached to each other by optical adhesive.

In the following, a liquid crystal slit grating will be taken as an example to describe the structure features of the disclosed stereoscopic 3D display device which adopts a single-layer grating to realize the landscape screen 3D display, the portrait screen 3D display, and the 2D display.

FIG. 11 illustrates a schematic diagram of another exemplary stereoscopic 3D display device consistent with disclosed embodiments. As shown in FIG. 11, the stereoscopic 3D display device may include a display screen 13 and a liquid crystal slit grating 15. The liquid crystal slit grating 15 may include a first polarizer 124, a first substrate 127, a liquid crystal layer 123, a second substrate 121, and a second polarizer 125 sequentially disposed. The first substrate 127 may be provided with a first electrode 122, and the second substrate 121 may be provided with a plurality of parallel second electrodes 126 arranged in the second direction. The liquid crystal layer 123 may be sandwiched between the first electrode 122 and the second electrode 126. The first electrode 122 may be a planar electrode, and the second electrode 126 may be a stripe-shaped electrode.

In one embodiment, as shown in FIG. 11, the liquid crystal slit grating 15 may be disposed on the light exit side of the display screen 13. In another embodiment, the liquid crystal slit grating 15 may be disposed on the light incident side of the display screen, and the polarizer at the bottom side of the liquid crystal slit grating 15 (for example, the polarizer 125 when the liquid crystal slit grating is disposed on the light incident side of the display screen) may be a brightness enhancement polarizer for increasing the output light of the stereoscopic 3D display device.

The liquid crystal slit grating may be a single-layer grating. In the 2D display mode, the landscape screen 3D display mode, and the portrait screen 3D display mode, a driving voltage may be applied to the first electrode 122 and the second electrodes 126, and the driving voltage may control the liquid crystal molecules to be deflected, such that the grating units may be formed, enabling the grating to enter the light-splitting state. The grating unit may be disposed obliquely with respect to the display screen 13, and an angle formed between the grating unit and the long side/short side the display screen 13 may be approximately between 30° and 40°.

In the landscape screen 3D display mode and the portrait screen 3D display mode, the left-eye image L and the right-eye image R of a 3D image may be arranged on the display screen 13. Based on the light-splitting function of the grating 15 and, more particular, the light-splitting function of the grating unit, the 3D display may be realized.

FIG. 12 illustrates a schematic diagram of another exemplary stereoscopic 3D display device consistent with disclosed embodiments. As shown in FIG. 12, the stereoscopic 3D display device may include, from bottom to top, a backlight module 27, a display panel 13, a second polarizer 25, a third optical adhesive layer 24, a grating 15, a fourth optical adhesive layer 22, and a glass cover plate 21. A first polarizer (not drawn in FIG. 12) may be disposed between the backlight module 27 and the display screen 26.

The grating 15 may be a solid lens grating, for example, a UV-LENS lens grating. The original state of the solid lens grating may be the light-spitting state, which includes a plurality of grating units. In the direction perpendicular to the extending direction of the grating unit, the cross-section of the grating unit may have a circular arc shape.

FIG. 13 illustrates a schematic diagram of another exemplary stereoscopic 3D display device consistent with disclosed embodiments. As shown in FIG. 13, the stereoscopic 3D display device in FIG. 13 may be similar to the structure of the stereoscopic 3D display device in FIG. 11. From bottom to top, the stereoscopic 3D display device in FIG. 13 may sequentially include, a backlight module 35, a display panel 13, an optical film 33, an optical adhesive layer 32, and a glass cover plate 31. The optical film 33 may include a second polarizer and a solid lens grating disposed on the second polarizer, such as a UV-LENS lens grating. The UV-LENS lens grating may be integrally formed with the second polarizer to form the optical film 33. A first polarizer (not drawn in FIG. 13) may also be disposed between the backlight module 35 and the display screen 13.

The solid lens grating includes a plurality of parallel-arranged curved lenses, and the bottom surface of the curved lens may coincide with the upper surface of the second polarizer.

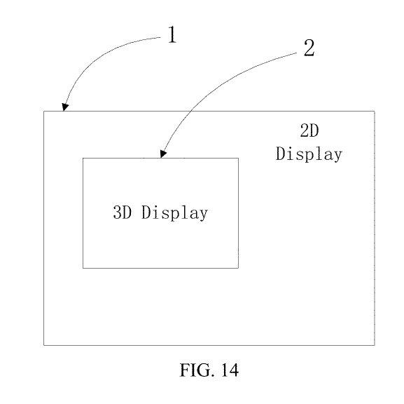

FIG. 14 illustrates a perspective view of an exemplary three-dimensional interface consistent with disclosed embodiments. As shown in FIG. 14, the stereoscopic 3D display in FIG. 14 may be similar to the stereoscopic 3D display in FIG. 1, in addition to the 2D display mode, the landscape stereoscopic 3D display mode and the portrait screen 3D display mode, the stereoscopic 3D display may be also compatible with the 2D/3D fusion display mode. That is, the 2D display and the 3D display mode may be fused and displayed on one display interface, and the 3D display may appear in any shapes at any positions on the display screen. The display screen may have one area which displays 3D content or multiple areas which display 3D content. In FIG. 14, the display area 1 is displaying 2D content, the display area 2 may display 3D content. For example, the area where the 2D content is displayed may mainly display text, and the area where the 3D content is displayed may mainly display images. The area where the 3D content is displayed may have various shapes, such as a rectangle, a circle, a rhombus, a regular hexagon, and a snowflake shape.

The disclosed disclosure further provides a grating which may be implemented into the disclosed stereoscopic 3D display device.

The grating may have a rectangular shape, and in the light-splitting state, the grating may include a plurality of grating units arranged in parallel. The grating units may be obliquely arranged with respect to the long side or the short side of the rectangle, and the angle between the grating unit and the long side or short side of the rectangle may be approximately between 30° to 40°. For example, the angle between the grating unit and the long side of the rectangle may be approximately 35°, or the angle between the grating unit and the short side of the rectangle may be approximately 35°.

The grating may be a dynamic grating which is capable of being switched on and switched off, or a stationary grating which is unable of being switched on and switched off.

The grating may be a lens grating or a slit grating, for example, a UV-LENS lens grating, a liquid crystal lens grating, a metal slit grating, a black matrix slit grating, and a liquid crystal slit grating, etc.

When the grating is a UV-LENS lens grating, in the direction perpendicular to the extending direction of the grating unit, the cross-section of the grating unit may have an arc shape, a sawtooth shape, or a bowl shape.

When the grating is a slit grating, the aperture ratio may be configured to be approximately between 30% and 45%.

For a detailed description of the grating, please refer to the foregoing embodiments, which will not be repeated here.

The present disclosure also provides a corresponding display method applied to the disclosed stereoscopic 3D display device.

Taking a relatively common mobile terminal device as an example of the stereoscopic 3D display device, the mobile terminal devices such as mobile phones, tablet computers, and game consoles may mainly have two stereoscopic display states/modes: a landscape screen 3D display state/mode and a portrait screen 3D display state/mode.

The display method applied to the disclosed stereoscopic 3D display device may include the following steps:

Step S1: determining a current display mode of the stereoscopic 3D display device;

Step S2: after determining the stereoscopic 3D display device is in the 2D display mode, performing 2D display of the to-be-displayed content;

Step S3: after determining the stereoscopic 3D display device is in the landscape screen 3D display mode, according to the landscape screen grating parameters, performing landscape screen 3D display of the to-be-displayed content; and

Step S4: after determining the stereoscopic 3D display device is in the portrait screen 3D display mode, according to the portrait screen grating parameters, performing portrait screen 3D display of the to-be-displayed content.

When the grating is a non-switchable solid-state grating, the driving of the grating may be eliminated, and the grating may be originally in the light-splitting state. When the grating is a dynamic grating capable of being switched-on and-off, to display images in each display mode, the grating may have to be activated/driven first. For example, a driving voltage may be applied to the grating form grating units, thereby enabling the grating to enter the light-splitting state.

In one embodiment, the landscape screen grating parameters and the portrait screen grating parameters may be stored in advance.

In another embodiment, one of the landscape screen grating parameters and the portrait screen grating parameters may be stored in advance, and the other of the landscape screen grating parameters and the portrait screen grating parameters may be calculated based the previously stored one. That is, a relationship between the landscape screen grating parameters and the portrait screen grating parameters may be stored in advance, based on which the other of the landscape screen grating parameters and the portrait screen grating parameters may be stored in advance may be calculated based the previously stored one.

For example, the landscape screen grating parameters and the portrait screen grating parameters may have the following relationship:

cot α₁*cot α₂=−1

t1=t2/cos^{α}^{₂}.

Δ1=Δ2/cot^{α}^{₂},

where α₁ is the grating tilt angle of the landscape screen grating parameters, α₂ is the grating tilt angle of the portrait screen grating parameters, t₁ is the grating period of the landscape screen grating parameters, t₂ is the grating period of the portrait screen grating parameters, and Δ₁ is the grating displacement of the landscape screen grating parameters, Δ₂ is the grating displacement of the portrait screen grating parameters.

During the stereoscopic display, regardless of the landscape screen orientation or portrait screen orientation, the beam/light-splitting direction of the grating may be always fixed. When the viewer's viewing position moves, it is very likely that the image originally to be sent to the left eye may be sent to the right eye, and the image originally to be sent to the right eye may be sent to the left eye. That is, after the viewer's viewing position is changed, 3D pseudoscopic images, ghost images, and distortion may be observed by the viewer.

Thus, after the viewer's viewing position is changed, to effectively ensure a correct stereoscopic display effect while suppressing 3D pseudoscopic images, ghost images, and distortion, a tracking display device with the tracking display function may be configured to track the viewer's viewing position, arrange the left-eye and right-eye images based on the viewer's viewing position and grating parameters, and display the 3D image. That is, after the viewer's viewing position is changed, the display content viewed by the viewer may be adjusted to ensure the accuracy of the views received by the left and right eyes, thereby effectively ensuring the correct stereoscopic display effect.

That is, in one embodiment, when the stereoscopic 3D display device is in the landscape screen 3D display mode, a first spatial viewing position of the viewer may be determined. According to the landscape screen grating parameters and the first spatial viewing position, the landscape screen 3D display may be performed on the to-be-displayed content.

That is, in one embodiment, when the stereoscopic 3D display device is in the portrait screen 3D display mode, a second spatial viewing position of the viewer may be determined. According to the portrait screen grating parameters and the second spatial viewing position, the portrait screen 3D display may be performed on the to-be-displayed content.

It should be noted that, the methods of determining the spatial viewing position of the viewer, as well as, the methods of performing stereoscopic display according to the grating parameters and the viewing position are not limited by the present disclosure. Those skilled in the art may select and use any appropriate well-known methods according to various application scenarios.

In one embodiment, the viewer may be face-recognized, and the position information of the viewer's facial features may be obtained, accordingly. Then the spatial viewing position of the viewer may be determined according to the viewer's facial feature position information. In another embodiment, an infrared emitter disposed on the viewer may be detected to obtain the spatial position information of the infrared emitter. Then according to the spatial position information of the infrared emitter, the spatial viewing position of the viewer may be determined.

To further optimize the stereoscopic display effect, a crosstalk optimization may be first performed on the to-be-displayed content in both the landscape screen 3D display mode and the portrait screen 3D display mode. After the crosstalk optimization, the 3D display may be performed on the to-be-displayed content. In one embodiment, the crosstalk optimization may include a histogram equalization process or a smoothing process of a boundary area in the to-be-displayed content.

To further optimize the 2D display effect, a smoothing object in the display content may be first smoothed. The smoothing object may include all 2D display content or a specific region in the 2D display content. The specific region in the 2D display content may refer to a region in which the 2D display effect is likely to be affected due to the presence of the grating, for example, the edge area of text or image. Then, the smoothed to-be-displayed content may be displayed in the 2D mode.

In one embodiment, the smoothing processing may be performed on the smoothing object in the to-be-displayed content by using a box filter algorithm, a mean filter algorithm, or a Gaussian filter algorithm. Here, the smoothing process refers to adjusting the pixel value of a pixel itself according to the pixel value of the pixels surrounding the pixel, thereby reducing the difference between the pixel value of the pixel itself and the pixel value of the surrounding pixels.

In another embodiment, when the stereoscopic 3D display device is a 2D/3D fusion display mode, the disclosed display method may further include:

determining a 3D display area and a 2D display area of the stereoscopic 3D display device; and

performing an autostereoscopic 3D display on the 3D display content in the to-be-displayed content in the 3D display area, and performing a 2D display on the 2D display content in the to-be-displayed content in the 2D display area, such that the autostereoscopic 3D display of the 3D display content and the 2D display of the 2D content are realized on the display screen at the same time.

In particular, performing an autostereoscopic 3D display on the 3D display content in the to-be-displayed content in the 3D display area may further include:

after determining the display orientation of the 3D display area of the stereoscopic 3D display device is the landscape screen orientation, performing the landscape screen 3D display on the 3D display content in the to-be-displayed content according to the landscape screen grating parameters; and

after determining the display orientation of the 3D display area of the stereoscopic 3D display device is the portrait screen orientation, performing the portrait screen 3D display on the 3D display content in the to-be-displayed content according to the portrait screen grating parameters.

Further, to optimize the 2D display effect, performing a 2D display on the 2D display content in the to-be-displayed content in the 2D display area may further include:

performing a smooth processing on an smoothing object in the 2D display content, wherein the smoothing object includes all 2D display content or a specific region in the 2D display content, and the specific region in the 2D display content refers to a region in which the 2D display effect is likely to be affected due to the setting of the grating, such as the edge area of text or image; and

performing the 2D display on the smoothed to-be-displayed content.

Further, performing a smooth processing on an smoothing object in the 2D display content may further include:

using a box filter algorithm, a mean filter algorithm, or a Gaussian filter algorithm to perform the smooth processing on the smoothing object in the 2D display content, wherein the smoothing process refers to adjusting the pixel value of a pixel itself according to the pixel value of the pixels surrounding the pixel, thereby reducing the difference between the pixel value of the pixel itself and the pixel value of the surrounding pixels.

After being combined with a specific calculation method, the stereoscopic 3D display method of the present disclosure may be described as follow:

determining a current display mode of the stereoscopic 3D display device, after determining the current display mode is a 2D display mode, performing the 2D display on the to-be-displayed content, and after determining the current display mode is a 3D display mode, detecting an orientation of the stereoscopic 3D display device, judging whether the stereoscopic 3D display device is currently placed in the landscape screen orientation or the portrait screen orientation, in one embodiment, the current orientation of the mobile terminal device may be determined by obtaining the data of a gyroscope disposed inside the mobile terminal device;

after determining that the stereoscopic 3D display device is currently placed in the landscape screen orientation and the landscape screen 3D display is desired (i.e., 3D images are viewed on the mobile terminal device in the landscape screen orientation), obtaining landscape screen grating parameters, such as the grating tilt angel θ1, the grating period pitch1, and the horizontal displacement of the grating offset1, and based on the three new parameters, calculating the position index index for each sub-pixel, then assigning values to the sub-pixel according to the position index index; and

after determining that the stereoscopic 3D display device is currently placed in the portrait screen orientation and the portrait screen 3D display is desired (i.e., 3D images are viewed on the mobile terminal device in the portrait screen orientation), obtaining portrait screen grating parameters, such as the grating tilt angel θ2, the grating period pitch2, and the horizontal displacement of the grating offset2. The above-mentioned portrait screen grating parameters may be obtained according to the prior art, and the details will be described herein.

In particular, after determining that the stereoscopic 3D display device is currently placed in the landscape screen orientation, the image arrangement algorithm in the stereoscopic display method may be applied to each sub-pixel on the display screen according to the values of the above three parameters. In particular, assuming the coordinates of the current sub-pixel is (x, y), the position index index of the position where the sub-pixel is located is calculated as:

index=(x+y*cot(θ1)−offset1)/pitch1.

Then the pixel value of the sub-pixel with the coordinates (x, y) may be determined according to the value of the position index index, such as how to assign a value as the pixel value of the sub-pixel with the coordinates (x, y), whether the pixel value of the sub-pixel with the coordinates (x, y) is the pixel value of the left-eye image or the pixel value of the right-eye image.

$$subpixel = \{ \begin{matrix}left [ x , y ] , & index < \frac{pitch}{2} \\ right [ x , y ] , & index \geq \frac{pitch}{2}\end{matrix} ,$$

where left[x,y], right[x,y] in the above equation refer to the pixel value obtained from a certain coordinate [x,y] in the left-eye image and the pixel value obtained from a certain coordinate [x,y] in the right-eye image, respectively. Here pitch is a grating period in the landscape screen orientation, which represents the horizontal width of the grating unit 150 when the display device is in the landscape screen orientation, i.e., the width of an individual grating unit 150 in the direction of the long side of the display screen.

After determining that the stereoscopic 3D display device is currently placed in the portrait screen orientation, the image arrangement algorithm in the stereoscopic display method may be applied to each sub-pixel on the display screen according to the values of the above-mentioned three portrait screen grating parameters. Although the above-mentioned three portrait screen grating parameters are changed when the stereoscopic 3D display device is currently placed in the portrait screen orientation, however, based on the three new parameters, the above algorithm logic may still be used to calculate the position index index for each sub-pixel and then assign the value to the sub-pixel based on the position index index as follow:

$$\begin{matrix}index = ( x + y * cot ( θ2 ) - offset 2 ) / pitch 2 , \\ subpixel = \{ \begin{matrix}left [ x , y ] , & index < \frac{pitch}{2} \\ right [ x , y ] , & index \geq \frac{pitch}{2}\end{matrix} ,\end{matrix}$$

Here pitch is a grating period in the portrait screen orientation, which represents the horizontal width of the grating unit 150 when the display device is in the portrait screen orientation, i.e., the width of an individual grating unit 150 in the direction of the short side of the display screen.

Through different parameter configurations, the above-mentioned image arrangement algorithm of the disclosed stereoscopic 3D display method may be compatible with both the landscape screen and portrait screen, through mainly changing the three parameters in the landscape screen 3D display mode and the portrait screen 3D display mode.

After the corresponding portrait or portrait screen image arrangement algorithm is completed, a corresponding 3D image may be displayed.

In the disclosed embodiments, the grating, stereoscopic 3D display device, and display method thereof may be compatible of a 2D display mode, a landscape screen 3D display mode and a portrait screen 3D display mode. The structure and driving may be substantially simple, the Moiré pattern appearing in both the landscape screen 3D display and portrait screen 3D display may be significantly suppressed, the occurrence of breakpoints and jagged edges in the displayed characters or images may be significantly weaken, thereby ensuring the display effect of the three display modes.

Optionally, the present disclosure provides stereoscopic 3D display device compatible of a 2D display mode, a landscape screen 3D display mode and a portrait screen 3D display mode, comprising: a display screen; and a grating arranged opposite to the display screen, wherein in each of the 2D display mode, the landscape screen 3D display mode and the portrait screen 3D display mode, the grating is in a light-splitting state. The grating includes a plurality of grating units arranged in parallel, a grating unit of the plurality of grating units is obliquely disposed with respect to a long side or a short side of the display screen, and an angle formed between the grating unit and the long side or the short side of the display screen is between 30° and 40°.

Optionally, the display screen includes a plurality of display units arranged in a matrix.

Optionally, the grating includes a lens grating or a slit grating, for example, the lens grating is a UV-LENS grating.

Optionally, in a direction perpendicular to an extending direction of the grating unit, a cross-section of a UV-LENS grating unit of the UV-LENS grating has a circular arc shape, a sawtooth shape, or a bowl shape.

Optionally, the UV-LENS grating is disposed on a light exit side of the display screen.

Optionally, the UV-LENS lens grating has a bottom surface facing the display screen and an opposing top surface far away from the display screen, a back adhesive is provided on the bottom surface of the UV-LENS lens grating, and the UV-LENS lens grating is attached to the display screen through the back adhesive; or the UV-LENS lens grating is attached to the display screen through an optical adhesive.

Optionally, a polarizer is disposed between the UV-LENS lens grating and the display screen; the UV-LENS lens grating has a bottom surface facing the display screen and an opposing top surface far away from the display screen, a back adhesive is provided on the bottom surface of the UV-LENS lens grating, and the UV-LENS lens grating is attached to the polarizer through the back adhesive; or the UV-LENS lens grating is attached to the polarizer through an optical adhesive.

Optionally, a polarizer is disposed between the UV-LENS lens grating and the display screen; and the UV-LENS lens grating and the polarizer is integrally formed.

Optionally, the grating includes the slit grating; and an aperture ratio of the slit grating is between 30% and 45%.

Optionally, the slit grating includes a stationary slit grating or a switchable dynamic slit grating.

Optionally, the stationary slit grating includes a metal slit grating or a black matrix (BM) slit grating.

Optionally, the switchable dynamic slit grating includes a liquid crystal slit grating.

Optionally, the liquid crystal slit grating is disposed on a light exit side of the display screen; and a polarizer is disposed between the liquid crystal slit grating and the display screen.

Optionally, the liquid crystal slit grating is disposed on a light incident side of the display screen; the liquid crystal slit grating has a top surface facing the display screen and a bottom surface far away from the display screen; and a brightness enhancement polarizer is disposed on the bottom surface of the liquid crystal slit grating.

Optionally, the display screen has a pixel density above 300 PPI.

Optionally, the stereoscopic 3D display device is compatible with a 2D/3D fusion display mode, and in the 2D/3D fusion display mode, the grating is in the light-splitting state.

Optionally, the angle formed between the grating unit and the long side or the short side of the display screen is 35°.

Optionally, the present disclosure provides a display method for a stereoscopic 3D display device compatible of a 2D display mode, a landscape screen 3D display mode and a portrait screen 3D display mode, comprising: a display screen; and a grating arranged opposite to the display screen, wherein in each of the 2D display mode, the landscape screen 3D display mode and the portrait screen 3D display mode, the grating is in a light-splitting state, wherein: the grating includes a plurality of grating units arranged in parallel, a grating unit of the plurality of grating units is obliquely disposed with respect to a long side or a short side of the display screen, and an angle formed between the grating unit and the long side or the short side of the display screen is between 30° and 40°. The display method comprises: determining a current display mode of the stereoscopic 3D display device; after determining the stereoscopic 3D display device is in the 2D display mode, performing 2D display of to-be-displayed content; after determining the stereoscopic 3D display device is in the landscape screen 3D display mode, according to landscape screen grating parameters, performing landscape screen 3D display of the to-be-displayed content; and after determining the stereoscopic 3D display device is in the portrait screen 3D display mode, according to portrait screen grating parameters, performing portrait screen 3D display of the to-be-displayed content, wherein in each of the 2D display mode, the landscape screen 3D display mode and the portrait screen 3D display mode, the grating is in the light-splitting state.

Optionally, when the grating a switchable dynamic grating, the display method further comprises: activating the grating to enter the light-splitting state.

Optionally, the landscape screen grating parameters and the portrait screen grating parameters are stored in advance, or one of the landscape screen grating parameters and the portrait screen grating parameters is stored in advance, and the other of the landscape screen grating parameters and the portrait screen grating parameters is calculated based the one stored in advance.

Optionally, the display method further comprises at least one of the following: after determining the stereoscopic 3D display device is in the landscape screen 3D display mode, determining a first spatial viewing position of a viewer, and according to the landscape screen grating parameters and the first spatial viewing position, performing the landscape screen 3D display of the to-be-displayed content; and after determining the stereoscopic 3D display device is in the portrait screen 3D display mode, determining a second spatial viewing position of a viewer, and according to the portrait screen grating parameters and the second spatial viewing position, performing the portrait screen 3D display of the to-be-displayed content.

Optionally, the display method further comprises at least one of the following: after determining the stereoscopic 3D display device is in the landscape screen 3D display mode, performing a crosstalk optimization on the to-be-displayed content, and according to the landscape screen grating parameters and the first spatial viewing position, performing the landscape screen 3D display of the crosstalk optimized to-be-displayed content; and after determining the stereoscopic 3D display device is in the portrait screen 3D display mode, performing a crosstalk optimization on the to-be-displayed content, and according to the portrait screen grating parameters and the second spatial viewing position, performing the portrait screen 3D display of the crosstalk optimized to-be-displayed content.

Optionally, the crosstalk optimization includes a histogram equalization process or a smoothing process of a boundary area in the to-be-displayed content.

Optionally, the stereoscopic 3D display device is compatible with a 2D/3D fusion display mode, and in the 2D/3D fusion display mode, the grating is in the light-splitting state. The display method further comprises: determining a 3D display area and a 2D display area of the display screen; and performing autostereoscopic 3D display on 3D display content in the to-be-displayed content in the 3D display area, and performing 2D display on 2D display content at the to-be-displayed content at the 2D display area, such that the autostereoscopic 3D display of the 3D display content and the 2D display of the 2D content are simultaneously realized on the display screen.

Optionally, the performing an autostereoscopic 3D display on 3D display content in the to-be-displayed content at the 3D display area further comprises: after determining the stereoscopic 3D display device is in the landscape screen 3D display mode, according to the landscape screen grating parameters, performing the landscape screen 3D display of the to-be-displayed content, after determining the stereoscopic 3D display device is in the portrait screen 3D display mode, according to the portrait screen grating parameters, performing the portrait screen 3D display of the to-be-displayed content.

Optionally, the performing 2D display on 2D display content in the to-be-displayed content at the 2D display area further comprises: performing a smooth processing on an smoothing object in the 2D display content, wherein the smoothing object includes all the 2D display content or a specific region in the 2D display content; and performing the 2D display on the smoothed 2D display content in the to-be-displayed content at the 2D display area.

Optionally, the smoothing processing an smoothing object in the 2D display content further comprises: using a box filter algorithm, a mean filter algorithm, or a Gaussian filter algorithm to perform the smooth processing on the smoothing object in the 2D display content.

Optionally, the present disclosure further provides a grating. The grating is applied to for a stereoscopic 3D display device compatible of a 2D display mode, a landscape screen 3D display mode and a portrait screen 3D display mode. In each of the 2D display mode, the landscape screen 3D display mode and the portrait screen 3D display mode, the grating is in a light-splitting state. The grating is a rectangle. The grating includes a plurality of grating units arranged in parallel. A grating unit of the plurality of grating units is obliquely disposed with respect to a long side or a short side of the rectangle; and an angle formed between the grating unit and the long side or the short side of the rectangle is between 30° and 40°.

Optionally, the grating includes a lens grating or a slit grating.

Optionally, the lens grating is a UV-LENS grating.

Optionally, in a direction perpendicular to an extending direction of the grating unit, a cross-section of a UV-LENS grating unit of the UV-LENS grating has a circular arc shape, a sawtooth shape, or a bowl shape.

Optionally, the grating includes the slit grating; and an aperture ratio of the slit grating is between 30% and 45%.

Optionally, the slit grating includes a stationary slit grating or a switchable dynamic slit grating.

Optionally, the stationary slit grating includes a metal slit grating or a black matrix (BM) slit grating.

Optionally, the switchable dynamic slit grating includes a liquid crystal slit grating.

Optionally, the angle formed between the grating unit and the long side or the short side of the rectangle is 35°.

The disclosed grating, stereoscopic 3D display device including the grating, and display method thereof may have the following features.

First, through configuring the tilt angle of the grating unit to be approximately between 30° and 40°, the 3D display in both the landscape screen 3D display mode and portrait screen 3D display mode (i.e., both the landscape screen 3D display and portrait screen 3D display) may be realized by a single grating (i.e., the same grating), the Moiré pattern appearing in the 3D display in both the landscape screen 3D display and portrait screen 3D display may be significantly suppressed, and the stereoscopic 3D display performance of both the landscape screen 3D display and portrait screen 3D display may be improved.

Second, the 2D display mode may be performed when the grating is in the light-splitting state, through configuring the tilt angle of the grating unit to be approximately between 30° and 40°, the occurrence of breakpoints and jagged edges in the displayed images (such as characters) may be significantly weakened, and the 2D display performance may be improved.

Third, because the grating may be always switched on when the stereoscopic 3D display device is in each of the 2D display mode, the landscape screen 3D display mode and portrait screen 3D display mode, a 2D/3D fusion display may be realized, i.e., the 2D display and the 3D display mode may be fused and displayed on one display interface, and the 3D display may appear in any shapes at any positions on the display screen.

Fourth, a single-grating structure/a single grating may be able to realize 2D display mode/landscape screen 3D display mode/portrait screen 3D display mode compatible, the structure of the stereoscopic 3D display device may be substantially simple, and the manufacturing process flow may be simplified.

Fifth, in each of the 2D display mode, the landscape screen 3D display mode and portrait screen 3D display mode, the grating may be always switched on to maintain the light-splitting state without switching-on and switching-off. Thus, the display driving may be simple. When a solid state stationary grating is used as the grating, the grating driving and the grating switching may be no longer involved. Thus, the display control may be simple and efficient, and the power consumption of the stereoscopic 3D display device may be reduced.

Last but not at least, the stereoscopic 3D display device including the grating may have a thin thickness, a small volume, a low cost and improved display performance.

Optionally, the present disclosure provides stereoscopic 3D display device, comprising: a display screen; and a grating arranged opposite to the display screen. The grating is a single-layer grating, when the grating is in a light-splitting state, the grating includes a plurality of grating units arranged in parallel. A grating unit of the plurality of grating units is obliquely disposed with respect to a long side or a short side of the display screen, and an angle formed between the grating unit and the long side or the short side of the display screen is between 30° and 40°.

Optionally, the grating is a non-switchable stationary grating maintaining the light-splitting state. The stereoscopic 3D display device is compatible of a 2D display mode, a landscape screen 3D display mode and a portrait screen 3D display mode. In each of the 2D display mode, the landscape screen 3D display mode and the portrait screen 3D display mode, the grating is in the light-splitting state.

Optionally, the grating is switchable dynamic grating. After being activated, the grating is in the light-splitting state, and after being deactivated, the grating is in a light-transmitting state. The stereoscopic 3D display device is compatible of a 2D display mode, a landscape screen 3D display mode and a portrait screen 3D display mode. In each of the 2D display mode, the landscape screen 3D display mode and the portrait screen 3D display mode, the grating is in the light-splitting state; or in the landscape screen 3D display mode and the portrait screen 3D display mode, the grating is in the light-splitting state, while in the 2D display mode, the grating is in the light-transmitting state.

Optionally, the stereoscopic 3D display device is compatible with a 2D/3D fusion display mode, and in the 2D/3D fusion display mode, the grating is in the light-splitting state.

Optionally, the stationary grating includes a lens grating or a slit grating.

Optionally, the lens grating is a UV-LENS grating.

Optionally, in a direction perpendicular to an extending direction of the grating unit, a cross-section of a UV-LENS grating unit of the UV-LENS grating has a circular arc shape, a sawtooth shape, or a bowl shape.

Optionally, the UV-LENS grating is disposed on a light exit side of the display screen.

Optionally, the UV-LENS lens grating has a bottom surface facing the display screen and an opposing top surface far away from the display screen, a back adhesive is provided on the bottom surface of the UV-LENS lens grating, and the UV-LENS lens grating is attached to the display screen through the back adhesive; or the UV-LENS lens grating is attached to the display screen through an optical adhesive.

Optionally, the UV-LENS grating is disposed on a light exit side of the display screen, and a polarizer is disposed between the UV-LENS lens grating and the display screen. The UV-LENS lens grating has a bottom surface facing the display screen and an opposing top surface far away from the display screen, a back adhesive is provided on the bottom surface of the UV-LENS lens grating, and the UV-LENS lens grating is attached to the polarizer through the back adhesive; or the UV-LENS lens grating is attached to the polarizer through an optical adhesive; or the UV-LENS lens grating and the polarizer are integrally formed.

Optionally, the switchable dynamic grating includes a liquid crystal slit grating.

Optionally, an aperture ratio of the liquid crystal slit grating is between 30% and 45%.

Optionally, the liquid crystal slit grating is disposed on a light exit side of the display screen, and a polarizer is disposed between the liquid crystal slit grating and the display screen; or the liquid crystal slit grating is disposed on a light incident side of the display screen, the liquid crystal slit grating has a top surface facing the display screen and a bottom surface far away from the display screen; and a brightness enhancement polarizer is disposed on the bottom surface of the liquid crystal slit grating.

Optionally, the angle formed between the grating unit and the long side or the short side of the display screen is 35°.

Optionally, the present disclosure provides a display method for a stereoscopic 3D display device stereoscopic 3D display device comprising: a display screen; and a grating arranged opposite to the display screen. The grating is a single-layer grating, when the grating is in a light-splitting state, the grating includes a plurality of grating units arranged in parallel. A grating unit of the plurality of grating units is obliquely disposed with respect to a long side or a short side of the display screen, and an angle formed between the grating unit and the long side or the short side of the display screen is between 30° and 40°. The display method comprises: determining a current display mode of the stereoscopic 3D display device; after determining the stereoscopic 3D display device is in the 2D display mode, performing 2D display of to-be-displayed content; after determining the stereoscopic 3D display device is in the landscape screen 3D display mode, according to landscape screen grating parameters, performing landscape screen 3D display of the to-be-displayed content; and after determining the stereoscopic 3D display device is in the portrait screen 3D display mode, according to portrait screen grating parameters, performing portrait screen 3D display of the to-be-displayed content.

Optionally, when the grating a switchable dynamic grating, the display method further comprises: in each of the landscape screen 3D display mode and the portrait screen 3D display mode, activating the grating to enter the light-splitting state, and in the 2D display mode, deactivating the grating to enter a light-transmitting state; or in each of the 2D display mode, the landscape screen 3D display mode and the portrait screen 3D display mode, activating the grating to enter the light-splitting state.

Optionally, the stereoscopic 3D display device is compatible with a 2D/3D fusion display mode, and the display method further comprises: determining a 3D display area and a 2D display area of the display screen; and performing autostereoscopic 3D display on 3D display content in the to-be-displayed content in the 3D display area, and performing 2D display on 2D display content at the to-be-displayed content at the 2D display area, such that the autostereoscopic 3D display of the 3D display content and the 2D display of the 2D content are simultaneously realized on the display screen. In the 2D/3D fusion display mode, the grating is in the light-splitting state.

Optionally, the performing an autostereoscopic 3D display on 3D display content in the to-be-displayed content at the 3D display area further comprises: after determining the stereoscopic 3D display device is in the landscape screen 3D display mode, according to the landscape screen grating parameters, performing the landscape screen 3D display of the to-be-displayed content, after determining the stereoscopic 3D display device is in the portrait screen 3D display mode, according to the portrait screen grating parameters, performing the portrait screen 3D display of the to-be-displayed content.

Optionally, the display method further comprises at least one of the following: after determining the stereoscopic 3D display device is in the landscape screen 3D display mode, performing a crosstalk optimization on the to-be-displayed content; and after determining the stereoscopic 3D display device is in the portrait screen 3D display mode, performing a crosstalk optimization on the to-be-displayed content.

Optionally, the performing 2D display on 2D display content in the to-be-displayed content at the 2D display area further comprises: performing a smooth processing on an smoothing object in the 2D display content. The smoothing object includes all the 2D display content or a specific region in the 2D display content of the to-be-displayed content.

Optionally, the present disclosure further provides a grating. The grating is a single-layer grating, and the grating is a rectangle. When the grating is in a light-splitting state, the grating includes a plurality of grating units arranged in parallel. A grating unit of the plurality of grating units is obliquely disposed with respect to a long side or a short side of the rectangle, and an angle formed between the grating unit and the long side or the short side of the rectangle is between 30° and 40°.

Optionally, the grating is a non-switchable stationary grating maintaining the light-splitting state.

Optionally, the grating is switchable dynamic grating. After being activated, the grating is in the light-splitting state, and after being deactivated, the grating is in a light-transmitting state.

Optionally, the stationary grating includes a lens grating or a slit grating.

Optionally, the lens grating is a UV-LENS grating.

Optionally, in a direction perpendicular to an extending direction of the grating unit, a cross-section of a UV-LENS grating unit of the UV-LENS grating has a circular arc shape, a sawtooth shape, or a bowl shape.

Optionally, the switchable dynamic grating includes a liquid crystal slit grating.

Optionally, an aperture ratio of the liquid crystal slit grating is between 30% and 45%.

Optionally, the angle formed between the grating unit and the long side or the short side of the rectangle is 35°.

The disclosed grating, stereoscopic 3D display device including the grating, and display method thereof may have the following features.

First, through configuring the tilt angle of the grating unit to be approximately between 30° and 40°, the 3D display in both the landscape screen 3D display mode and portrait screen 3D display mode (i.e., both the landscape screen 3D display and portrait screen 3D display) may be realized by a single-layer grating, the Moiré pattern appearing in the 3D display in both the landscape screen 3D display and portrait screen 3D display may be significantly suppressed, and the stereoscopic 3D display performance of both the landscape screen 3D display and portrait screen 3D display may be improved.

Second, the 2D display mode may be performed when the grating is in the light-splitting state, through configuring the tilt angle of the grating unit to be approximately between 30° and 40°, the occurrence of breakpoints and jagged edges in the displayed images (such as characters) may be significantly weakened, and the 2D display performance may be improved.

Third, because the grating may be always switched on when the stereoscopic 3D display device is in each of the 2D display mode, the landscape screen 3D display mode and portrait screen 3D display mode, a 2D/3D fusion display may be realized, i.e., the 2D display and the 3D display mode may be fused and displayed on one display interface, and the 3D display may appear in any shapes at any positions on the display screen.

Fourth, a single-grating structure/a single-layer grating may be able to realize 2D display mode/landscape screen 3D display mode/portrait screen 3D display mode compatible, the structure of the stereoscopic 3D display device may be substantially simple, and the manufacturing process flow may be simplified.

Fifth, in each of the 2D display mode, the landscape screen 3D display mode and portrait screen 3D display mode, the grating may be always switched on to maintain the light-splitting state without switching-on and switching-off. Thus, the display driving may be simple. When a solid state stationary grating is used as the grating, the grating driving and the grating switching may be no longer involved. Thus, the display control may be simple and efficient, and the power consumption of the stereoscopic 3D display device may be reduced.

Last but not at least, the stereoscopic 3D display device including the grating may have a thin thickness, a small volume, a low cost and improved display performance.

Optionally, the present disclosure provides a stereoscopic 3D display device compatible of a 2D display mode, a landscape screen 3D display mode and a portrait screen 3D display mode, comprising: a display screen; and a grating arranged opposite to the display screen. A shape and a size of the grating is matched with a shape and a size of the display screen, respectively. The grating is a single grating, and the single grating is a UV-LENS grating including a plurality of grating units arranged in parallel. A grating unit of the plurality of grating units is obliquely disposed with respect to a long side or a short side of the display screen, and an angle formed between the grating unit and the long side or the short side of the display screen is between 30° and 40°.

Optionally, the display screen includes a plurality of display units arranged in a matrix.

Optionally, in a direction perpendicular to an extending direction of the grating unit, a cross-section of the grating unit has a circular arc shape, a sawtooth shape, or a bowl shape.

Optionally, the grating is disposed on a light exit side of the display screen.

Optionally, the grating has a bottom surface facing the display screen and an opposing top surface far away from the display screen, a back adhesive is provided on the bottom surface of the grating, and the grating is attached to the display screen through the back adhesive; or the grating is attached to the display screen through an optical adhesive.

Optionally, a polarizer is disposed between the grating and the display screen; the grating has a bottom surface facing the display screen and an opposing top surface far away from the display screen, a back adhesive is provided on the bottom surface of the grating, and the grating is attached to the polarizer through the back adhesive; or the grating is attached to the polarizer through an optical adhesive.

Optionally, a polarizer is disposed between the grating and the display screen; and the grating and the polarizer is integrally formed.

Optionally, the display screen has a pixel density above 300 PPI.

Optionally, the stereoscopic 3D display device is compatible with a 2D/3D fusion display mode.

Optionally, the angle formed between the grating unit and the long side or the short side of the display screen is 35°.

Optionally, the stereoscopic 3D display device further comprises a glass cover plate, and the glass cover plate is disposed at a light exit side of the grating.

Optionally, the glass cover plate is attached to the grating by an optical adhesive layer.

Optionally, the display screen is a touch control display screen.

Optionally, the present disclosure provides a display method for a stereoscopic 3D display device compatible of a 2D display mode, a landscape screen 3D display mode and a portrait screen 3D display mode, comprising: a display screen; and a grating arranged opposite to the display screen. A shape and a size of the grating is matched with a shape and a size of the display screen, respectively. The grating is a single grating, and the single grating is a UV-LENS grating including a plurality of grating units arranged in parallel. A grating unit of the plurality of grating units is obliquely disposed with respect to a long side or a short side of the display screen, and an angle formed between the grating unit and the long side or the short side of the display screen is between 30° and 40. The display method comprises: determining a current display mode of the stereoscopic 3D display device; after determining the stereoscopic 3D display device is in the 2D display mode, performing 2D display of to-be-displayed content; after determining the stereoscopic 3D display device is in the landscape screen 3D display mode, according to landscape screen grating parameters, performing landscape screen 3D display of the to-be-displayed content; and after determining the stereoscopic 3D display device is in the portrait screen 3D display mode, according to portrait screen grating parameters, performing portrait screen 3D display of the to-be-displayed content, wherein in each of the 2D display mode, the landscape screen 3D display mode and the portrait screen 3D display mode, the grating is in the light-splitting state.

Optionally, the landscape screen grating parameters and the portrait screen grating parameters are stored in advance, or one of the landscape screen grating parameters and the portrait screen grating parameters is stored in advance, and the other of the landscape screen grating parameters and the portrait screen grating parameters is calculated based the one stored in advance.

Optionally, the display method further comprises: after determining the stereoscopic 3D display device is in the landscape screen 3D display mode, determining a first spatial viewing position of a viewer, and according to the landscape screen grating parameters and the first spatial viewing position, performing the landscape screen 3D display of the to-be-displayed content.

Optionally, the display method further comprises: after determining the stereoscopic 3D display device is in the portrait screen 3D display mode, determining a second spatial viewing position of a viewer, and according to the portrait screen grating parameters and the second spatial viewing position, performing the portrait screen 3D display of the to-be-displayed content.

Optionally, the display method further comprises at least one of the following: after determining the stereoscopic 3D display device is in the landscape screen 3D display mode, performing a crosstalk optimization on the to-be-displayed content, and according to the landscape screen grating parameters and the first spatial viewing position, performing the landscape screen 3D display of the crosstalk optimized to-be-displayed content; and after determining the stereoscopic 3D display device is in the portrait screen 3D display mode, performing a crosstalk optimization on the to-be-displayed content, and according to the portrait screen grating parameters and the second spatial viewing position, performing the portrait screen 3D display of the crosstalk optimized to-be-displayed content.

Optionally, the crosstalk optimization includes a histogram equalization process or a smoothing process of a boundary area in the to-be-displayed content.

Optionally, the stereoscopic 3D display device is compatible with a 2D/3D fusion display mode. The display method further comprises: determining a 3D display area and a 2D display area of the display screen; and performing autostereoscopic 3D display on 3D display content in the to-be-displayed content in the 3D display area, and performing 2D display on 2D display content at the to-be-displayed content at the 2D display area, such that the autostereoscopic 3D display of the 3D display content and the 2D display of the 2D content are simultaneously realized on the display screen.

Optionally, the performing an autostereoscopic 3D display on 3D display content in the to-be-displayed content at the 3D display area further comprises: after determining the stereoscopic 3D display device is in the landscape screen 3D display mode, according to the landscape screen grating parameters, performing the landscape screen 3D display of the to-be-displayed content, after determining the stereoscopic 3D display device is in the portrait screen 3D display mode, according to the portrait screen grating parameters, performing the portrait screen 3D display of the to-be-displayed content.

Optionally, the performing 2D display on 2D display content in the to-be-displayed content at the 2D display area further comprises: performing a smooth processing on an smoothing object in the 2D display content, wherein the smoothing object includes all the 2D display content or a specific region in the 2D display content; and performing the 2D display on the smoothed 2D display content in the to-be-displayed content at the 2D display area.

Optionally, the smoothing processing an smoothing object in the 2D display content further comprises: using a box filter algorithm, a mean filter algorithm, or a Gaussian filter algorithm to perform the smooth processing on the smoothing object in the 2D display content.

Optionally, the present disclosure provides a grating applied to a stereoscopic 3D display device compatible of a 2D display mode, a landscape screen 3D display mode and a portrait screen 3D display mode. A shape and a size of the grating is matched with a shape and a size of the display screen, respectively. The grating is a single grating, and the single grating is a UV-LENS grating including a plurality of grating units arranged in parallel. The UV-LENS grating is a rectangle. A grating unit of the plurality of grating units is obliquely disposed with respect to a long side or a short side of the rectangle, and an angle formed between the grating unit and the long side or the short side of the rectangle is between 30° and 40°.

Optionally, in a direction perpendicular to an extending direction of the grating unit, a cross-section of the grating unit has a circular arc shape, a sawtooth shape, or a bowl shape.

Optionally, the angle formed between the grating unit and the long side or the short side of the rectangle is 35°.

The disclosed grating, stereoscopic 3D display device including the grating, and display method thereof may have the following features.

First, through configuring the tilt angle of the grating unit to be approximately between 30° and 40°, the 3D display in both the landscape screen 3D display mode and portrait screen 3D display mode (i.e., both the landscape screen 3D display and portrait screen 3D display) may be realized by a single grating (i.e., the same grating), the Moiré pattern appearing in the 3D display in both the landscape screen 3D display and portrait screen 3D display may be significantly suppressed, and the stereoscopic 3D display performance of both the landscape screen 3D display and portrait screen 3D display may be improved.

Second, the 2D display mode may be performed when the grating is in the light-splitting state, through configuring the tilt angle of the grating unit of the UN-LENS grating to be approximately between 30° and 40°, the occurrence of breakpoints and jagged edges in the displayed images (such as characters) may be significantly weakened, and the 2D display performance may be improved.

Third, because the grating is a single-layer UV-LENS grating which may be always switched on when the stereoscopic 3D display device is in each of the 2D display mode, the landscape screen 3D display mode and portrait screen 3D display mode, a 2D/3D fusion display may be realized, i.e., the 2D display and the 3D display mode may be fused and displayed on one display interface, and the 3D display may appear in any shapes at any positions on the display screen.

Fourth, a single-layer UV-LENS grating (i.e., a UV-LENS grating with a single-grating structure) may be able to realize 2D display mode/landscape screen 3D display mode/portrait screen 3D display mode compatible, the structure of the stereoscopic 3D display device may be substantially simple, and the manufacturing process flow may be simplified.

Fifth, because the grating is a single-layer UV-LENS grating, which may be always switched on to maintain the light-splitting state in each of the 2D display mode, the landscape screen 3D display mode and portrait screen 3D display mode. Thus, the switching-on and switching-off of the grating may be no longer involved, the display driving may be simple, accordingly.

Last but not at least, the stereoscopic 3D display device including the grating may have a thin thickness, a small volume, a low cost and improved display performance.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A stereoscopic 3D display device compatible of a 2D display mode, a landscape screen 3D display mode and a portrait screen 3D display mode, comprising:
a display screen; and
a grating arranged opposite to the display screen, wherein in each of the 2D display mode, the landscape screen 3D display mode and the portrait screen 3D display mode, the grating is in a light-splitting state,
wherein:
the grating includes a plurality of grating units arranged in parallel,
a grating unit of the plurality of grating units is obliquely disposed with respect to a long side or a short side of the display screen, and
an angle formed between the grating unit and the long side or the short side of the display screen is between 30° and 40°.

2. The stereoscopic 3D display device according to claim 1, wherein:
the display screen includes a plurality of display units arranged in a matrix.

3. The stereoscopic 3D display device according to claim 2, wherein:
the grating includes a lens grating or a slit grating.

4. The stereoscopic 3D display device according to claim 3, wherein:
the lens grating is a UV-LENS grating.

5. The stereoscopic 3D display device according to claim 4, wherein:
in a direction perpendicular to an extending direction of the grating unit, a cross-section of a UV-LENS grating unit of the UV-LENS grating has a circular arc shape, a sawtooth shape, or a bowl shape.

6. The stereoscopic 3D display device according to claim 4, wherein:
the UV-LENS grating is disposed on a light exit side of the display screen.

7. The stereoscopic 3D display device according to claim 6, wherein:
the UV-LENS lens grating has a bottom surface facing the display screen and an opposing top surface far away from the display screen, a back adhesive is provided on the bottom surface of the UV-LENS lens grating, and the UV-LENS lens grating is attached to the display screen through the back adhesive; or
the UV-LENS lens grating is attached to the display screen through an optical adhesive.

8. The stereoscopic 3D display device according to claim 6, wherein:
a polarizer is disposed between the UV-LENS lens grating and the display screen;
the UV-LENS lens grating has a bottom surface facing the display screen and an opposing top surface far away from the display screen, a back adhesive is provided on the bottom surface of the UV-LENS lens grating, and the UV-LENS lens grating is attached to the polarizer through the back adhesive; or
the UV-LENS lens grating is attached to the polarizer through an optical adhesive.

9. The stereoscopic 3D display device according to claim 6, wherein:
a polarizer is disposed between the UV-LENS lens grating and the display screen; and
the UV-LENS lens grating and the polarizer is integrally formed.

10. The stereoscopic 3D display device according to claim 3, wherein:
the grating includes the slit grating; and
an aperture ratio of the slit grating is between 30% and 45%.

11. The stereoscopic 3D display device according to claim 3, wherein:
the slit grating includes a stationary slit grating or a switchable dynamic slit grating.

12. The stereoscopic 3D display device according to claim 11, wherein:
the stationary slit grating includes a metal slit grating or a black matrix (BM) slit grating.

13. The stereoscopic 3D display device according to claim 11, wherein:
the switchable dynamic slit grating includes a liquid crystal slit grating.

14. The stereoscopic 3D display device according to claim 13, wherein:
the liquid crystal slit grating is disposed on a light exit side of the display screen; and
a polarizer is disposed between the liquid crystal slit grating and the display screen.

15. The stereoscopic 3D display device according to claim 13, wherein:
the liquid crystal slit grating is disposed on a light incident side of the display screen;
the liquid crystal slit grating has a top surface facing the display screen and a bottom surface far away from the display screen; and
a brightness enhancement polarizer is disposed on the bottom surface of the liquid crystal slit grating.

16. The stereoscopic 3D display device according to claim 1, wherein:
the display screen has a pixel density above 300 PPI.

17. The stereoscopic 3D display device according to claim 1, wherein:
the stereoscopic 3D display device is compatible with a 2D/3D fusion display mode, wherein:
in the 2D/3D fusion display mode, the grating is in the light-splitting state.

18. The stereoscopic 3D display device according to claim 1, wherein:
the angle formed between the grating unit and the long side or the short side of the display screen is 35°.

19. A display method for a stereoscopic 3D display device compatible of a 2D display mode, a landscape screen 3D display mode and a portrait screen 3D display mode, comprising: a display screen; and a grating arranged opposite to the display screen, wherein in each of the 2D display mode, the landscape screen 3D display mode and the portrait screen 3D display mode, the grating is in a light-splitting state, wherein: the grating includes a plurality of grating units arranged in parallel, a grating unit of the plurality of grating units is obliquely disposed with respect to a long side or a short side of the display screen, and an angle formed between the grating unit and the long side or the short side of the display screen is between 30° and 40°, the display method comprises:
determining a current display mode of the stereoscopic 3D display device;
after determining the stereoscopic 3D display device is in the 2D display mode, performing 2D display of to-be-displayed content;
after determining the stereoscopic 3D display device is in the landscape screen 3D display mode, according to landscape screen grating parameters, performing landscape screen 3D display of the to-be-displayed content; and
after determining the stereoscopic 3D display device is in the portrait screen 3D display mode, according to portrait screen grating parameters, performing portrait screen 3D display of the to-be-displayed content,
wherein in each of the 2D display mode, the landscape screen 3D display mode and the portrait screen 3D display mode, the grating is in the light-splitting state.

20. The display method according to claim 19, wherein when the grating a switchable dynamic grating, the display method further comprises:
activating the grating to enter the light-splitting state.

21. The display method according to claim 19, wherein:
the landscape screen grating parameters and the portrait screen grating parameters are stored in advance, or
one of the landscape screen grating parameters and the portrait screen grating parameters is stored in advance, and the other of the landscape screen grating parameters and the portrait screen grating parameters is calculated based the one stored in advance.

22. The display method according to claim 19, further comprising at least one of the following:
after determining the stereoscopic 3D display device is in the landscape screen 3D display mode, determining a first spatial viewing position of a viewer, and according to the landscape screen grating parameters and the first spatial viewing position, performing the landscape screen 3D display of the to-be-displayed content; and
after determining the stereoscopic 3D display device is in the portrait screen 3D display mode, determining a second spatial viewing position of a viewer, and according to the portrait screen grating parameters and the second spatial viewing position, performing the portrait screen 3D display of the to-be-displayed content.

23. The display method according to claim 22, further comprising at least one of the following:
after determining the stereoscopic 3D display device is in the landscape screen 3D display mode, performing a crosstalk optimization on the to-be-displayed content, and according to the landscape screen grating parameters and the first spatial viewing position, performing the landscape screen 3D display of the crosstalk optimized to-be-displayed content; and
after determining the stereoscopic 3D display device is in the portrait screen 3D display mode, performing a crosstalk optimization on the to-be-displayed content, and according to the portrait screen grating parameters and the second spatial viewing position, performing the portrait screen 3D display of the crosstalk optimized to-be-displayed content.

24. The display method according to claim 23, wherein:
the crosstalk optimization includes a histogram equalization process or a smoothing process of a boundary area in the to-be-displayed content.

25. The display method according to claim 19, wherein the stereoscopic 3D display device is compatible with a 2D/3D fusion display mode, and in the 2D/3D fusion display mode, the grating is in the light-splitting state, the display method further comprises:
determining a 3D display area and a 2D display area of the display screen; and
performing autostereoscopic 3D display on 3D display content in the to-be-displayed content in the 3D display area, and performing 2D display on 2D display content at the to-be-displayed content at the 2D display area, such that the autostereoscopic 3D display of the 3D display content and the 2D display of the 2D content are simultaneously realized on the display screen,
wherein the performing an autostereoscopic 3D display on 3D display content in the to-be-displayed content at the 3D display area further comprises:
after determining the stereoscopic 3D display device is in the landscape screen 3D display mode, according to the landscape screen grating parameters, performing the landscape screen 3D display of the to-be-displayed content,
after determining the stereoscopic 3D display device is in the portrait screen 3D display mode, according to the portrait screen grating parameters, performing the portrait screen 3D display of the to-be-displayed content.

26. The display method according to claim 25, wherein the performing 2D display on 2D display content in the to-be-displayed content at the 2D display area further comprises:
performing a smooth processing on an smoothing object in the 2D display content, wherein the smoothing object includes all the 2D display content or a specific region in the 2D display content; and
performing the 2D display on the smoothed 2D display content in the to-be-displayed content at the 2D display area.

27. The display method according to claim 26, wherein the smoothing processing an smoothing object in the 2D display content further comprises:
using a box filter algorithm, a mean filter algorithm, or a Gaussian filter algorithm to perform the smooth processing on the smoothing object in the 2D display content.

28. A grating, wherein:
the grating is applied to for a stereoscopic 3D display device compatible of a 2D display mode, a landscape screen 3D display mode and a portrait screen 3D display mode;
in each of the 2D display mode, the landscape screen 3D display mode and the portrait screen 3D display mode, the grating is in a light-splitting state;
the grating is a rectangle;
the grating includes a plurality of grating units arranged in parallel;
a grating unit of the plurality of grating units is obliquely disposed with respect to a long side or a short side of the rectangle; and
an angle formed between the grating unit and the long side or the short side of the rectangle is between 30° and 40°.

29. The grating according to claim 28, wherein:
the grating includes a lens grating or a slit grating.

30. The grating according to claim 29, wherein:
the lens grating is a UV-LENS grating.

31. The grating according to claim 30, wherein:
in a direction perpendicular to an extending direction of the grating unit, a cross-section of a UV-LENS grating unit of the UV-LENS grating has a circular arc shape, a sawtooth shape, or a bowl shape.

32. The grating according to claim 29, wherein:
the grating includes the slit grating; and
an aperture ratio of the slit grating is between 30% and 45%.

33. The grating according to claim 29, wherein:
the slit grating includes a stationary slit grating or a switchable dynamic slit grating.

34. The grating according to claim 33, wherein:
the stationary slit grating includes a metal slit grating or a black matrix (BM) slit grating.

35. The grating according to claim 33, wherein:
the switchable dynamic slit grating includes a liquid crystal slit grating.

36. The grating according to claim 28, wherein:
the angle formed between the grating unit and the long side or the short side of the rectangle is 35°.
